(19) United States
(12) Patent Application Publication
(10) Pub. No.: US 2025/0384626 A1
(43) Pub. Date: Dec. 18, 2025

(54) FRACTAL TERRAIN STEREOSCOPIC VISUALIZATION IMAGE GENERATION SYSTEM AND FRACTAL TERRAIN STEREOSCOPIC VISUALIZATION IMAGE GENERATION PROGRAM

(71) Applicant: ASIA AIR SURVEY CO., LTD., Tokyo (JP)

(72) Inventor: Tatsuro CHIBA, Tokyo (JP)

(73) Assignee: ASIA AIR SURVEY CO., LTD., Tokyo (JP)

(21) Appl. No.: 19/241,200

(22) Filed: Jun. 17, 2025

Related U.S. Application Data
(63) Continuation of application No. PCT/JP2023/045314, filed on Dec. 18, 2023.

(30) Foreign Application Priority Data
Dec. 21, 2022 (JP) 2022-204675

(51) Int. Cl. G06T 17/05; G06F 16/29; G06T 3/4007; G06T 17/20; G06T 19/20

(52) U.S. Cl. CPC G06T 17/05; G06F 16/29; G06T 3/4007; G06T 17/205; G06T 19/20; G06T 2219/2012; G06T 2219/2016

(57) ABSTRACT

To generate a fractal terrain stereoscopic visualization image in which jaggies are absent, the terrain appears to be floating, and fine portions of the terrain are represented in detail. By being constituted of a ground map memory 110, a red stereoscopic image generator 120, an area reading unit 140, a 50 m-DEM thinning converter 160, a miniaturization processor 180, a moving average unit 210, a multiply synthesizer 220, a blurred 5 m-DEM smooth red stereoscopic image generator 250, a fractal stereoscopic image generator 260, a display processor 280, and the like, a fractal terrain stereoscopic visualization image with a stereoscopic effect can be obtained in which jaggies are absent, the terrain appears to be floating, and fine portions of the terrain are represented in detail.

This application is a continuation of International Application No. PCT/JP2023/045314, filed on Dec. 18, 2023 which claims the benefit of priority of the prior Japanese Patent Application No. 2022-204675, filed on Dec. 21, 2022, the entire contents of which are incorporated herein by reference.

### TECHNICAL FIELD

The present invention relates to a fractal terrain stereoscopic visualization image generation system.

### BACKGROUND ART

In recent years, the Geospatial Information Authority of Japan (hereinafter referred to as the “Geospatial Information Authority” or “GSI”) has released the Digital Elevation Model (DEM) scheme on the Internet.

Using the DEM scheme, the Geospatial Information Authority has recently has published a red relief image map according to Patent Literature 1.

The outline of the red relief image map encompasses a step of obtaining a slope gradient, an over-ground openness and an under-ground openness using, for example, the 5 m-DEM (five-meters interval Digital Elevation Model), and a step of obtaining a ridge-valley value (also called “an elevation-depression degree”) from the slope gradient, the over-ground openness and the under-ground openness, and a step of creating the red relief image map using chroma saturations of red colors assigned to each slope gradient and brightness of red colors assigned to the ridge-valley values.

This allowed for the simultaneous representation of microtopography as well as large terrain.

In addition, Patent Literature (PTL) 2 discloses a super-resolution stereoscopic visualization processing system.

The super-resolution stereoscopic visualization processing system according to Patent Literature 2 defines, in a plane-rectangular coordinate, a cluster of meshes represented by latitude and longitude of a predetermined area (for example, 1 km×1 km) in a digital elevation model (depending on location, a longitudinal trapezoid, or a rectangle).

The processing system then calculates a divide-distance which evenly divides a side along an X direction of each of the cluster of the meshes defined in the plane-rectangular coordinate into an odd number other than one.

The processing system then divides a two-dimensional plane (X-Y) of an area corresponding to the predetermined area (for example, 1 km×1 km) by the divide-distance to define super-resolution fine meshes (approximately 55 cm), each having a size of the divide-distance.

The processing system then defines a cluster of meshes (5 m×5 m) in the plane-rectangular coordinate on the two-dimensional plane (X-Y) to determine interpolated elevation values obtained by interpolating elevation values of the super-resolution fine meshes (approximately 55 cm), and generates a square moving average filter (smoothing meshes (5 m×5 m)) implemented by a cluster of smoothing grid-cells, each of which having a cell size of the divide-distance as the smoothing grid-cells and which are two-dimensionally arranged by the odd number.

The processing system then sequentially designates the super-resolution fine meshes (approximately 55 cm) defined in the two-dimensional plane (X-Y), for each designated super-resolution fine mesh, allocates a central smoothing grid-cell in the square moving average filter (smoothing meshes (5 m×5 m)) to the super-resolution fine mesh, and defines the moving average filter (smoothing meshes (5 m×5 m)) in the two-dimensional plane (X-Y).

The processing system then obtains a smoothing elevation value having been smoothed based on the cluster of the interpolated elevation value of the cluster of super-resolution fine meshes in the moving average filter (smoothing meshes (5 m×5 m)) and assigns the smoothing elevation value to the designated super-resolution fine mesh.

The processing system then specifies the super-resolution fine mesh as a subject point each time the smoothing elevation-values are assigned to the respective super-resolution fine meshes in the two-dimensional plane (X-Y), for each subject point, defines consideration distances from the subject point by the number of super-resolution fine meshes corresponding to the divide-distance to determine an elevation-depression degree within the number of super-resolution fine meshes, and performs a red stereoscopic visualization process of displaying the elevation-depression degree in gradation (for example, in red).

### CITATION LIST

### Patent Literature

[Patent Literature 1] Japanese Patent No. 3670274
[Patent Literature 2] Japanese Patent No. 6692984

### SUMMARY OF INVENTION

### Technical Problem

However, while the red relief image map in PTL 1 is able to simultaneously represent microtopography and large terrain, the map gives a flat impression when even larger terrain is viewed.

For example, each DEM has a different size of terrain that can be represented stereoscopically. A 0.5 m-DEM is a product of laser measurement.

The 5 m-DEM is published in base maps of the Geospatial Information Authority of Japan. A 50 m-DEM is used as a topographic feature by prefecture. A 500 m-DEM is used for the topography of the entire Japanese archipelago. A 5 km-DEM is used for the seafloor topography of the entire globe.

FIG. 46(a) illustrates the entire globe (4 km-DEM), FIG. 46(b) illustrates the 500 m-DEM used by the Japan Coast Guard, and FIG. 46(c) illustrates an example of the 50 m-DEM of the Geospatial Information Authority converted into a red image.

In addition, FIG. 46(d) illustrates an example of a 10 m-DEM of the Geospatial Information Authority converted into a red image (Mount Fuji), FIG. 46(e) illustrates an example of a 1 m-DEM obtained by laser measurement converted into a red image, and FIG. 46(f) is a partially enlarged view of FIG. 46(e).

In other words, the 1 m-DEM red relief image map with a consideration distance of 50 m which is a result of laser measurement is optimized for field surveys but it looks flat when Mount Fuji as a whole is viewed as it is. The consideration distance of 50 m is insufficient in terms of stereoscopically expressing Mount Fuji. Therefore, while microtopography and large terrain can be represented simultaneously, when looking at even larger terrain, the impression of flatness cannot be avoided.

On the other hand, since PTL 2 is super resolution (high resolution), a state of unevenness of the terrain is shown in detail but it is difficult to make out protrusions of large terrain.

In contrast, since PTL 1 provides a lower resolution than PTL 2, although large terrain is well represented, details of microtopography are blurred.

### Solution to Problem

A fractal terrain stereoscopic visualization image generation system according to the present invention includes: a storage that stores a DEM of terrain defined by a mesh of a certain size as a digital elevation model;
(A). means of obtaining a first slope gradient and a first elevation-depression degree based on a DEM of terrain of a predetermined area of the digital elevation model and a DEM of terrain within a consideration distance and generating a stereoscopic visualization image in a first gradation color of a combination of the first elevation-depression degree and the first slope gradient;
(B). means of generating a large mesh several times larger than a mesh of the DEM of terrain of the predetermined area, and reading a certain number of clusters of points of the DEM of terrain in a thinned manner into the large mesh to generate a low-density large mesh DEM;
(C). means of applying an interpolation process to the low-density large mesh to generate miniaturized low-density fine meshes, and assigning an interpolated elevation value to each low-density fine mesh;
(D). means of sequentially performing a moving average process for each low-density fine mesh to determine a moving average of the interpolated elevation values;
(E). means of designating each low-density fine mesh as a subject point after a moving average process is performed by the means (D), obtaining a second slope gradient and a second elevation-depression degree based on a moving-averaged elevation value of the low-density fine mesh at the subject point and a moving-averaged elevation value of the low-density fine mesh within the consideration distance, and generating an image of a combination of the second elevation-depression degree and the second slope gradient to which a second gradation color is assigned as a “blurred” stereoscopic visualization image; and
(F). means of synthesizing the stereoscopic visualization image and the “blurred” stereoscopic visualization image by multiplication and outputting the synthesized image as a fractal terrain stereoscopic visualization image.

### Advantageous Effect of Invention

As described above, according to the present invention, a fractal terrain stereoscopic visualization image with a stereoscopic effect can be obtained in which jaggies are absent, the terrain appears to be floating, and fine portions of the terrain are represented in detail.

### BRIEF DESCRIPTION OF DRAWINGS

FIG. 1 is a flowchart illustrating a concept of a fractal terrain stereoscopic visualization image generation system according to a present embodiment.

FIG. 2 is an explanatory diagram of a fractal terrain stereoscopic visualization image KGi obtained in the present embodiment.

FIG. 3 is a program block diagram of the fractal terrain stereoscopic visualization image generation system.

FIG. 4 is an explanatory diagram of an example of imaging of a 50 m-DEM mesh.

FIG. 5 is an explanatory diagram of an image (slope gradient) obtained by coloring a base map (5 m-DEM: 5.5555e-5).

FIG. 6 is an explanatory diagram of an image (slope gradient) of a “DEM thinned to approximately 50 m-mesh”.

FIG. 7 is an explanatory diagram of a 5 m-DEM base image Gai and a “thinned 50 m-DEM elevation image Gbi”.

FIG. 8 is an explanatory diagram of a 10×10 interpolation process.

FIG. 9 is an explanatory diagram of a bilinear-interpolated image GRi.

FIG. 10 is an explanatory diagram of images obtained by performing a high-level graduated coloring process on a base map (5 m-DEM (A)) and a “50 m-DEM thinned to 5 m-DEM”.

FIG. 11 is an explanatory diagram of a 9×9 moving average mesh Fmi.

FIG. 12 is an explanatory diagram of a 50 m-DEM thinned to 5 m-DEM smoothed and blurred image AGi.

FIG. 13 is an explanatory diagram of blurred 5 m-DEM smoothed data hgi.

FIG. 14 is an explanatory diagram of a completed 5 m-mesh smooth red stereoscopic image GHi.

FIG. 15 is an explanatory diagram of a case where a slope gradient ai is made to correspond to a distance axis.

FIG. 16 is an explanatory diagram of a multiply-synthesized red stereoscopic visualization image GHi before color adjustment.

FIG. 17 is an explanatory diagram of an overall generation process of a red stereoscopic image.

FIG. 18 is an explanatory diagram (1) of a generation process of a red stereoscopic image.

FIG. 19 is an explanatory diagram (2) of the generation process of a red stereoscopic image.

FIG. 20 is an explanatory diagram of an overall generation process of a red stereoscopic image of a mountain.

FIG. 21 is a block diagram of a program of a red stereoscopic image generator 120.

FIG. 22 is a schematic configuration diagram explaining a convexity-emphasis image generator 11 and a concavity-emphasis image generator 12.

FIG. 23 is a schematic configuration diagram explaining an inclination emphasizer 13.

FIG. 24 is an explanatory diagram of a gray scale.

FIG. 25 is an explanatory diagram of a correspondence relationship between the slope gradient αi and a distance value of the red stereoscopic image generator 120.

FIG. 26 is an explanatory diagram of a fractal terrain stereoscopic visualization image KGi obtained by enlarging a part of FIG. 2.

FIG. 27 is a comparative explanatory diagram of a red stereoscopic image and the fractal terrain stereoscopic visualization image KGi.

FIG. 28 is an explanatory diagram of a process from thinning clusters of points of a 5 m-DEM red stereoscopic image DEM to obtaining the fractal terrain stereoscopic visualization image KGi.

FIG. 29 is an explanatory diagram of a case where a general 5 m-DEM red stereoscopic map image Ki and a 50 m-DEM red stereoscopic image are simply synthesized by multiplication.

FIG. 30 is an explanatory diagram of problems in a case where a general 5 m-DEM red stereoscopic map image Ki and a 50 m-DEM red stereoscopic image are simply synthesized by multiplication.

FIG. 31 is an explanatory diagram of a multiply synthesis of a 50 cm-DEM and a 50 m-DEM of Mount Asama and its surroundings.

FIG. 32 is a schematic flowchart (1) explaining a Lab color fractal terrain stereoscopic visualization image generation system.

FIG. 33 is a schematic flowchart (2) explaining the Lab color fractal terrain stereoscopic visualization image generation system.

FIG. 34 is an explanatory diagram of each image according to the present embodiment.

FIG. 35 is a schematic configuration diagram of the Lab color fractal terrain stereoscopic visualization image generation system.

FIG. 36 is a schematic configuration diagram of a L*a*b* color unit 320.

FIG. 37 is an explanatory diagram of each spectrum.

FIG. 38 is an explanatory diagram of conversion of each openness and slope gradient.

FIG. 39 is a scatter diagram illustrating over-ground openness and under-ground openness.

FIG. 40 is a schematic configuration diagram of a third embodiment.

FIG. 41 is an explanatory diagram of a 10 m-mesh smooth L*a*b* color-imparted image HLai.

FIG. 42 is an explanatory diagram of a 5 m-DEM L*a*b* color image KLi.

FIG. 43 is an explanatory diagram of a 5 m-DEM L*a*b* color-imparted image Lbi.

FIG. 44 is an explanatory diagram of a L*a*b* color-imparted fractal image HKLi.

FIG. 45 is an explanatory diagram explaining how calculations can take the earth system into account.

FIG. 46 is an explanatory diagram of various conventional DEM images.

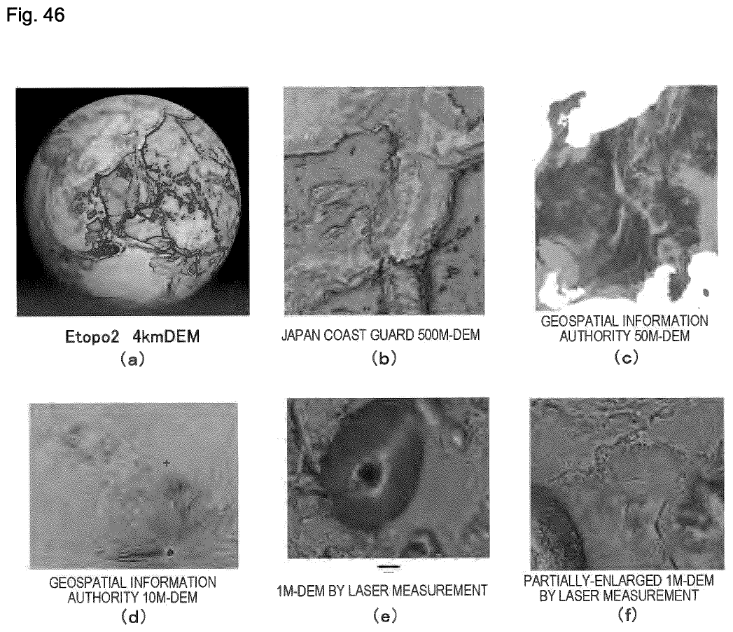

### DESCRIPTION OF EMBODIMENTS

The embodiments of the present invention described below exemplify apparatuses and methods to embody the technical ideas (structure and arrangement) and the technical ideas of the present invention are not specified to the following. The technical ideas of the present invention may be modified in various ways within the scope of the claims. It should also be noted that the drawings are schematic and the configuration of apparatuses and systems may differ from reality.

Procedures of obtaining a fractal terrain stereoscopic visualization image KGi at high speed will be described using a base map (hereinafter referred to as a 5 m-DEM base map Fa) that is a 5 m-DEM (A: A denotes laser) digital elevation model of the Geospatial Information Authority as an example.

In addition, a red stereoscopic visualization image (also referred to as a red relief image map) is used in the present embodiment. Although different colors such as blue, green, yellow-green, and the like may be used depending on target areas, seasons, and the like, since reddish colors such as red, purple, vermilion, orange, yellow, and the like will be used in the description of the present embodiment, the term red stereoscopic visualization image (also referred to as a red relief image map) will be used. Note that for oceans, lakes, rivers, and the like, blue and brown are preferably used.

An outline of the present invention will be described.

Although a red relief image map is capable of simultaneously representing microtopography and large terrain, when looking at even larger terrain, the impression of flatness cannot be avoided. While attempts were made to solve this problem by synthesizing a red relief image map with an increased DEM size by multiplication, jaggies were noticeable when the map was viewed up close.

In consideration thereof, in the present embodiment, after increasing the DEM size of a target area (5 m-DEM of the Geospatial Information Authority), a miniaturization process (also referred to as a super-resolution process) is added to realize smoothing, and a resultant red relief image map is overlaid, thereby solving the jaggies problem and achieving a higher speed.

As a result, a fractal terrain stereoscopic visualization image KGi is obtained which takes into account a fractal nature of terrain and which provides both an improved stereoscopic effect when viewed from a distance and ease of observation and sensitivity to detail when viewed up close.

Terrain comes in a variety of sizes and has different characteristics at different scales, even at the same location. While conventional maps involve switching images according to scale, it would be useful to have a red relief image map that could simultaneously represent microtopography and large terrain in a single image. Red relief image maps have greatly expanded their possibilities, and those which have been further expanded to different scales are referred to as fractal terrain stereoscopic visualization images KGi.

The present embodiment solves an insufficient stereoscopic effect of, for example, a 5 m-DEM red relief image map by a thinning super-resolution process. Note that an openness consideration distance is about 50 pixels (equivalent to 50 m in 1 m-DEM). This is because a significant calculation time is required when consideration distance is set to 500 pixels (equivalent to 2500 m in 50 m-DEM and to 250 m in 5 m-DEM).

Thinning 5 m-DEM to 50 m-DEM and creating and synthesizing a 50-pixel red relief image map produces a stereoscopic effect but jaggies are noticeable.

However, the present embodiment achieves both a detailed representation of the terrain and a stereoscopic effect over a wide area by thinning a 5 m-DEM to 50 m-DEM to create a 5 m-DEM miniaturized image (also referred to as super-resolution) and performing a smoothing process on the 5 m-DEM miniaturized image to create a “blurred image”, and synthesizing the “blurred image” and the stereoscopic visualization image.

Note that the DEM sizes are simply an example and DEMs of other sizes such as a 1 m-DEM by a laser measurement can also be used.

### First Embodiment

To summarize the embodiment, after increasing a DEM size of a Geospatial Information Authority base map (for example, a 5 m-DEM) by several times (for example, to a 10 m-DEM), a miniaturization process (super-resolution process) is applied to the 10 m-DEM (for example, to form a 5 m-DEM). Then, the 5 m-DEM is subjected to a moving average process (also referred to as a smoothing process).

Then, a red relief image map created based on the Geospatial Information Authority base map (for example, a 5 m-DEM) is overlaid to generate a fractal terrain stereoscopic visualization image KGi according to the present embodiment in which jaggies are suppressed. The fractal terrain stereoscopic visualization image KGi provides a stereoscopic effect when viewed from a distance (high points are high) and sensitivity to detail when viewed up close.

In other words, it is a red relief image map which takes into account the fractal nature of terrain and which provides a greater stereoscopic effect when viewed from a distance but also clarifies fine terrain when viewed up close. Note that the red relief image map may or may not be synthesized with contours, building drawings, city maps, and the like.

In addition, a DEM (Digital Elevation Model) is defined by assigning latitude, longitude, elevation, and the like to a mesh of squares.

The meaning of “over-sampling (miniaturization) to odd numbers” differs in its definition depending on how representative points are taken.

For example, when representative points are assigned to any of corners of a mesh, a division is performed including a point between two points (latitudinal direction, longitudinal direction).

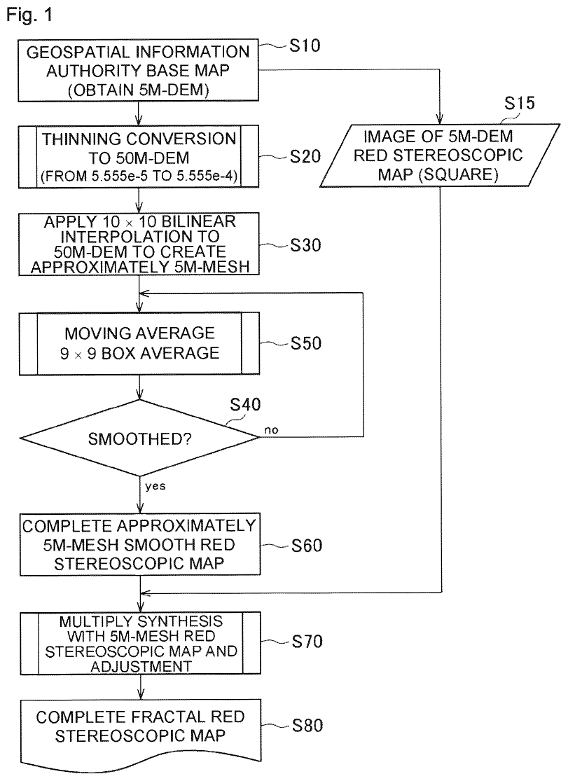

FIG. 1 is a flowchart illustrating a concept of a fractal terrain stereoscopic visualization image generation system according to the present embodiment.

As illustrated in FIG. 1, a base map (5 m-DEM (A)) defined using latitude and longitude of the Geospatial Information Authority stored in a memory is read (S10). Preferably, a 5 m-DEM of a designated predetermined area Ei is read.

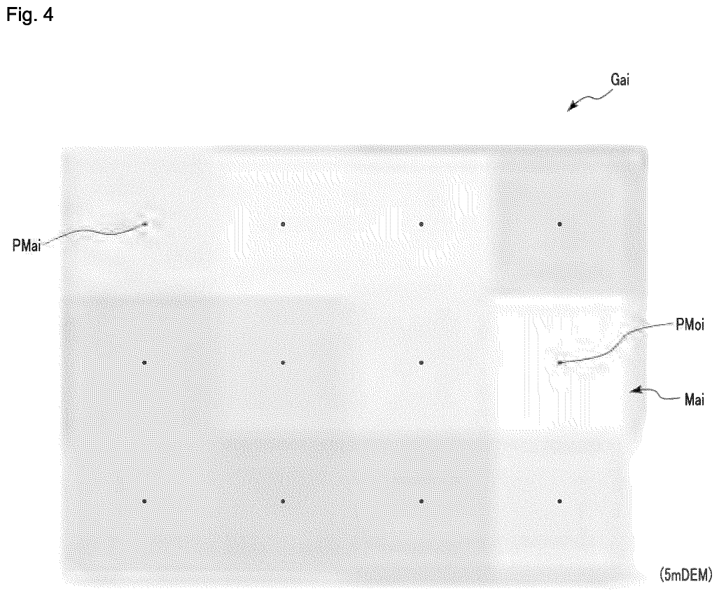

The base map (5 m-DEM (A)) is a digital elevation model that is a set of 5 m-DEMs in which clusters of points acquired at regular intervals (10 cm, 20 cm, 50 cm, 60 cm, 1 m, 2 m, . . . ) by laser measurement are divided into a mesh of evenly spaced 5 m-squares (frames), and a center of each square is provided with data such as an elevation value (Z) as a representative value. FIG. 4 illustrates an image with color values assigned according to elevation values of the 5 m-DEM 5 m-mesh Mai. Note that PMoi in FIG. 4 denotes a median.

In addition, a DEM of a 5 m-DEM red stereoscopic map image (hereinafter, referred to as a red stereoscopic image 5 m-DEM) is generated (S15). Preferably, a 5 m-DEM red stereoscopic map image Ki is generated and displayed based on the red stereoscopic image 5 m-DEM. The generation will be described later.

On the other hand, the 5 m-DEM read in step S10 is converted by thinning into a 50 m-DEM (S20). Specifically, 5.555e-5 (10 to the power of minus 5) becomes 5.555e-4 (10 to the power of minus 4). Thinning out 1 in 10 (clusters of points) (to 1/100th) is preferable (2 in 10, 3 in 10, 4 in 10 is also acceptable).

Then, the 50 m-DEM is subjected to 10×10 interpolation (TIN bilinear interpolation) to create a 50 m-DEM with a fine mesh (also referred to as a super-resolution fine mesh or a low-density fine mesh) of an approximately 5 m-mesh (hereinafter, referred to as “50 m-DEM thinned to 5 m-DEM” (S30).

In addition, the 50 m-DEM mesh is also referred to as a low-density large mesh.

Since the 50 m low-density large mesh is subdivided into a 5 m-mesh, in the present embodiment, a 5 m-mesh is referred to as a fine mesh (also referred to as a super-resolution fine mesh or a low-density fine mesh).

Next, a smoothing process is performed by applying a 9×9 moving average mesh (also referred to as a filter: 9×9 box average) to each “50 m-DEM thinned to 5 m-DEM: after super-resolution”, and the thinned image is displayed on a screen (S50).

The image after the moving average is referred to as a “50 m-DEM thinned to 5 m-DEM smoothed and blurred image AGi” (also referred to as a 5 m-DEM smoothed and blurred image or a super-resolution 5 m smoothed and blurred image).

Then, an operator determines whether or not the “50 m-DEM thinned to 5 m-DEM smoothed and blurred image AGi” is smooth (S40).

When it is determined that the image AGi is not smooth, the smoothing process of step S50 is performed once again.

When it is determined in step S40 that the image AGi is smooth, the image AGi is stored in a memory as a “completed 50 m-DEM thinned to 5 m-DEM smoothed and blurred red DEM”, and using the “completed 50 m-DEM thinned to 5 m-DEM smoothed and blurred red DEM”, a red stereoscopic image (hereinafter, referred to as a completed 5 m-mesh smooth red stereoscopic image GHi″ is generated in a memory (S60). The completed 5 m-mesh smooth red stereoscopic image GHi (after miniaturization: also simply referred to as a “blurred” stereoscopic visualization image) will be described later.

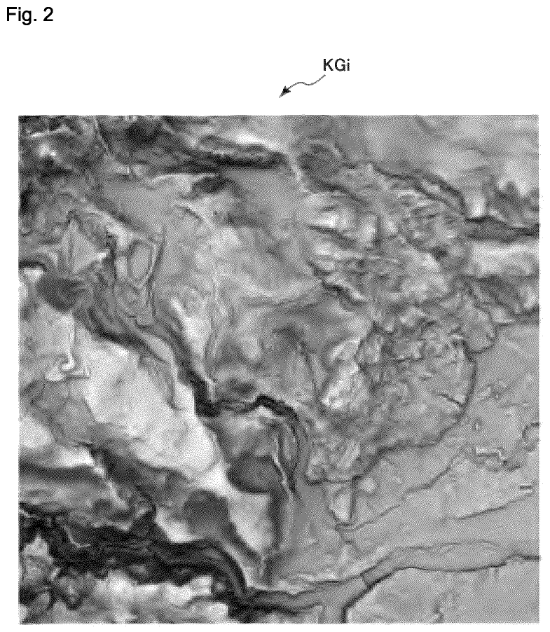

Then, the 5 m-DEM red stereoscopic map image Ki (no miniaturization) generated in step S15 and the “completed 5 m-mesh smooth red stereoscopic image GHi (after miniaturization)” are synthesized by multiplication and color values are adjusted (S70), and stored as a “fractal red stereoscopic completed DEM” in a memory (S80). An image based on the “fractal red stereoscopic completed DEM” is referred to as a fractal terrain stereoscopic visualization image KGi (refer to FIG. 2).

As illustrated in FIG. 2, it is obvious that the “fractal terrain stereoscopic visualization image KGi” provides a greater stereoscopic effect due to the absence of jaggies, an appearance of the terrain as though the terrain is floating, and representation of fine portions of the terrain being provided in detail.

Note that the DEM size of the base map is an example, and DEMs of other sizes such as a 1 m-DEM due to laser measurement may be used instead.

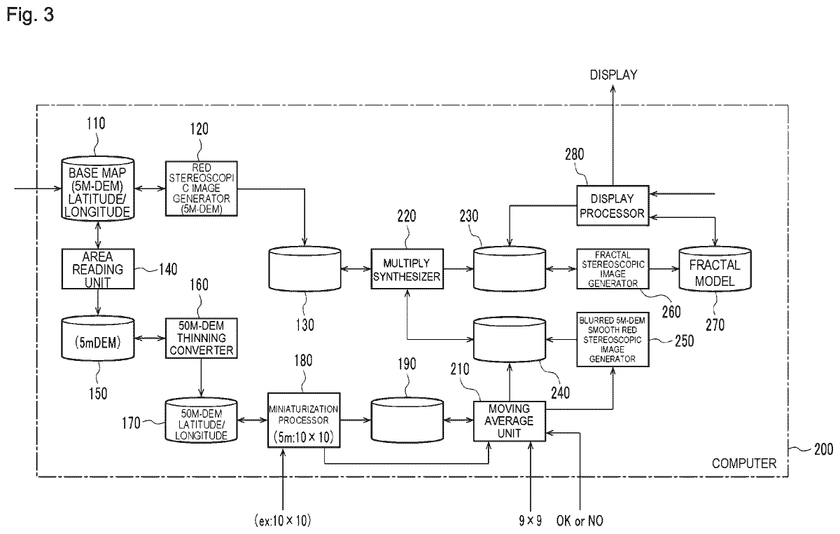

FIG. 3 is a program block diagram of the fractal terrain stereoscopic visualization image generation system according to the present embodiment.

As illustrated in FIG. 3, a computer 200 is constituted of a CPU, a RAM, a ROM, and the like (not illustrated) and loads a program configured as described below from the ROM to the RAM. Although the memory is not a program, the memory is illustrated in FIG. 3 for descriptive purposes.

The fractal terrain stereoscopic visualization image generation system is constituted of a ground map memory 110 storing a base map (5 m-DEM) defined by latitude and longitude, a red stereoscopic image generator 120, an area reading unit 140, a 50 m-DEM thinning converter 160, a miniaturization processor 180, a moving average unit 210, a multiply synthesizer 220, a blurred 5 m-DEM smooth red stereoscopic image generator 250, a fractal stereoscopic image generator 260, a display processor 280, and the like.

### (Description of System Components)

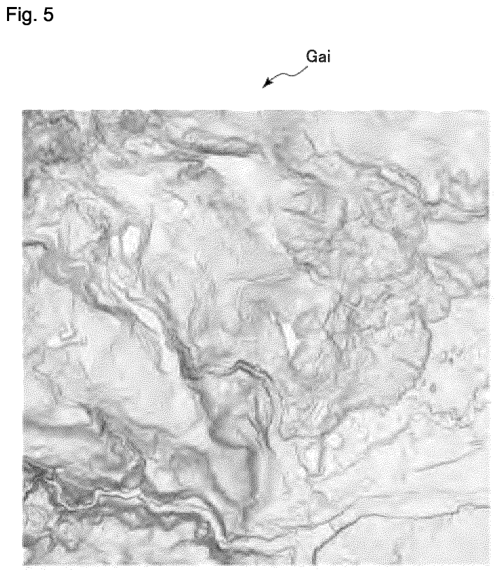

The ground map memory 110 stores a base map (5 m-DEM: square mesh) defined by latitude and longitude. Specifically, latitude is expressed on an X axis and longitude is expressed on a Y axis (not plane-rectangular coordinates of the map). An image created by coloring (inclinations in reddish colors) the base map (5 m-DEM: 5.5555e-5) is illustrated in FIG. 5.

In the present embodiment, this is referred to as a 5 m-DEM base image Gai (or also referred to as a Geospatial Information Authority base map elevation color image (5 mA)). The 5 m-DEM base image Gai is an image obtained by the red stereoscopic image generator 120 (having a red stereoscopic image generation process) to be described later.

The area reading unit 140 reads an entered area Ei (1 km, 2 km, 5 km, 10 km, 20 km, 30 km, 50 km, 100 km, 200 km, . . . ) from the ground map memory 110 to a memory 150 (defined by latitude and longitude).

The 50 m-DEM thinning converter 160 defines a cluster of 50 m-meshes (frames) represented by latitude and longitude in a memory 170.

Then, for each 5 m-DEM mesh of the base map in the memory 150, a predetermined number of clusters of points is thinned from the clusters of points that exist in the 5 m-DEM mesh and read into the 50 m-mesh (low-density large mesh) in the memory 170.

In other words, the 5 m-DEM (5.5555e-5) becomes 5.5555e-4 (also referred to as “50 m-DEM thinned to approximately 50 m-mesh”, “low-resolution 50 m-mesh DEM”, or “blurred DEM for 50 m-mesh large terrain”).

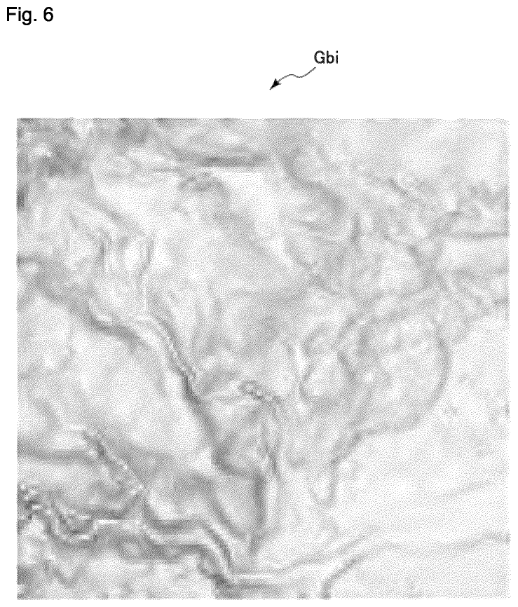

FIG. 6 illustrates an image (Gbi) of the “DEM thinned to approximately 50 m-mesh” of the area Ei (slope gradients displayed in color: reddish). As illustrated in FIG. 6, the entire area is blurred. This image is referred to as a “thinned 50 m-DEM elevation image Gbi” in the present embodiment.

The “thinned 50 m-DEM elevation image Gbi” is an image obtained by the red stereoscopic image generation process (not illustrated).

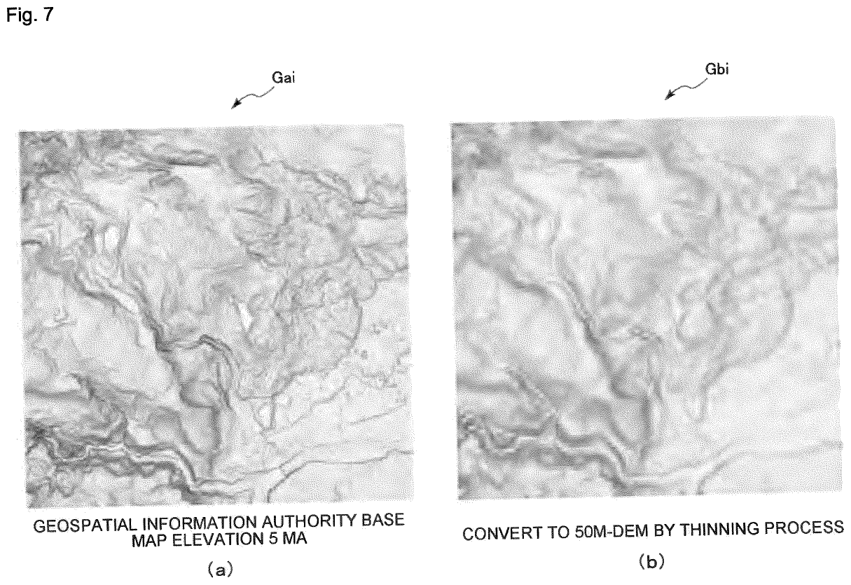

FIG. 7(a) illustrates the 5 m-DEM base image Gai (or Geospatial Information Authority base map elevation color image (5 mA)) and FIG. 7(b) illustrates the “thinned 50 m-DEM elevation image Gbi” which will now be described.

While the 5 m-DEM base image Gai shows the shape of the terrain, unevenness, and the like in detail, the “thinned 50 m-DEM elevation image Gbi” is blurred throughout as illustrated in FIG. 7(b).

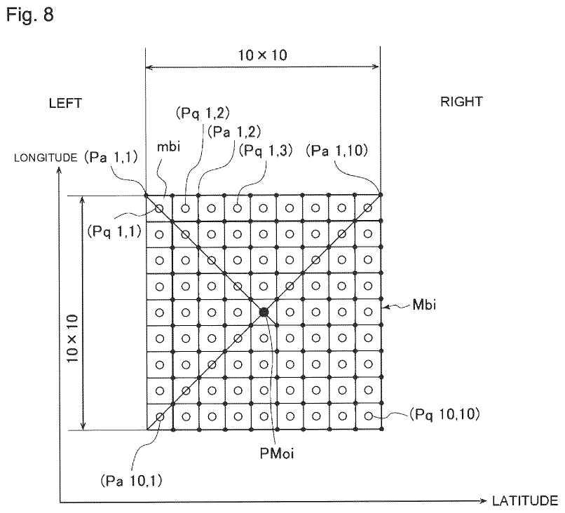

The miniaturization processor 180 performs a 10×10 interpolation process (bilinear interpolation: refer to FIG. 8) with respect to the “blurred DEM for 50 m-mesh large terrain (5.5555e-4)” in the memory 170 to obtain a “50 m-DEM thinned 5 m-DEM: ends are blurred”.

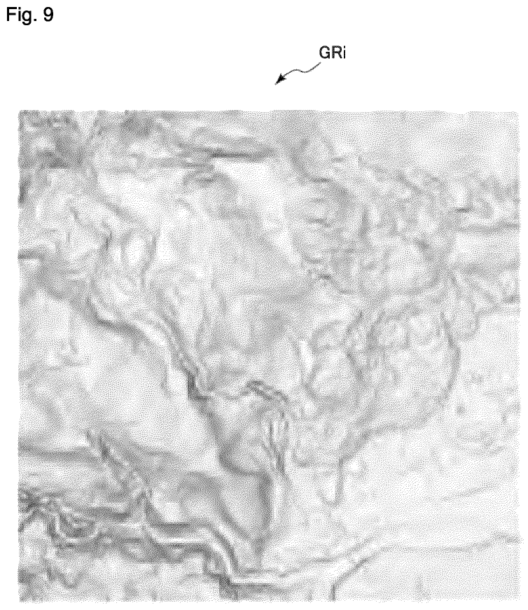

The image (hereinafter, referred to as a bilinear-interpolated image GRi) is displayed on a screen of a display (not illustrated) by the display processor 280 (refer to FIG. 9). The “bilinear-interpolated image GRi” is an image obtained by the red stereoscopic image generation process (not illustrated).

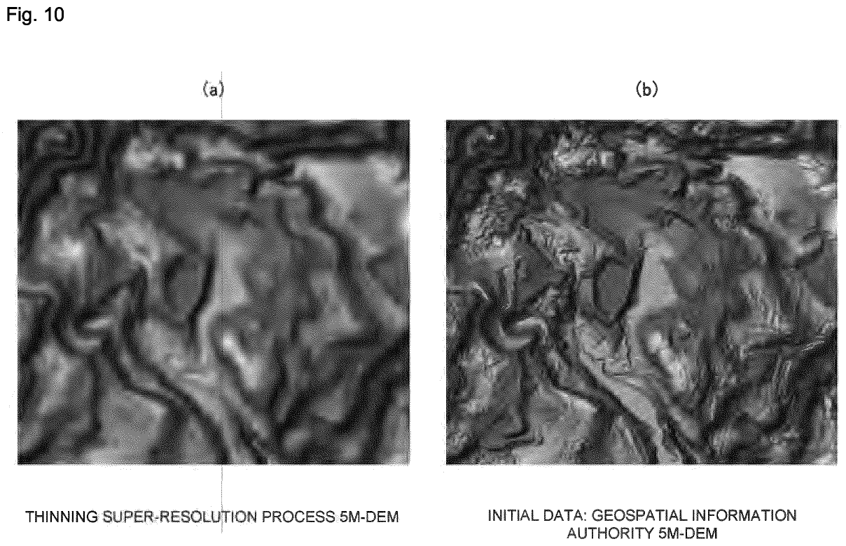

Note that FIG. 10 illustrates images obtained by performing a high-level graduated coloring process on the base map (5 m-DEM (A)) and the “50 m-DEM thinned 5 m-DEM”. FIG. 10(b) is an image obtained by performing a high-level graduated coloring process on the base map (5 m-DEM (A)) that is initial data and FIG. 10(a) is an image obtained by performing a high-level graduated coloring process on the “50 m-DEM thinned 5 m-DEM”.

Compared to the image obtained by performing a high-level graduated coloring process on the base map (5 m-DEM (A)) illustrated in FIG. 10(b), the high-level graduated coloring process on the “50 m-DEM thinned 5 m-DEM” illustrated in FIG. 10(a) and created by a thinning process is blurred throughout.

The miniaturization processor 180 defines a memory 190 with a divide-distance da (approximately 5 m) for equally dividing, into 10 parts, an edge along a latitudinal direction (X direction) and an edge along a longitudinal direction (Y direction) of the 50 m-mesh of the “blurred DEM for 50 m-mesh large terrain (5.5555e-4): 5 m” (for area Ea). In other words, a cluster of fine meshes whose longitudinal and lateral widths are the divide-distance da (approximately 5 m) (hereinafter, referred to as a “blurred fine 5 m-mesh mbi”) is defined by latitude and longitude.

Then, a 50 m-mesh Mbi whose longitudinal and lateral widths are 50 m×50 m is sequentially defined on the “blurred fine 5 m-mesh mbi”. In other words, the 50 m-mesh Mbi is to be equally divided into 10 parts so as to include points of two corners in the latitudinal direction (X direction) (points of two corners in the longitudinal direction (Y direction)).

Then, clusters of points of the “blurred DEM for 50 m-mesh large terrain (5.5555e-4)” are read to each 50 m-mesh Mbi in the memory 190.

Note that a size of each “blurred fine 5 m-mesh mbi (also referred to as a low-density fine mesh)” of the 50 m-mesh Mbi is equivalent to 5 m (equivalent to 0.2 seconds).

Then, for each 50 m-mesh Mbi, TIN bilinear interpolation (also referred to as interpolation) is performed as illustrated in FIG. 8 on the 50 m-mesh Mbi (square) to assign an elevation value of each “blurred fine 5 m-mesh mbi” (hereinafter, referred to as interpolated elevation value zri) (the elevation value is assigned to centers (Pqij: Pq1, 1, . . . ) in FIG. 8 (alternatively, the elevation value may be assigned to corners)).

In addition, in FIG. 8, points of the interpolated elevation value zri are described as 5 m-DEM fine mesh points Paij [(Pa1, 1), (Pa2, 1), . . . , (Pa10, 10)] (corners of the “blurred fine 5 m-mesh mbi”).

Note that when the interpolated elevation value zri of the fine 5 m-mesh mbi cannot be determined unless points of the four corners are known, the interpolated elevation value zri is preferably virtually calculated using a virtual mesh (not illustrated) of a cluster of 11×11 (size equivalent to 0.2 seconds).

The 5 m-DEM fine mesh points Paij are stored as 50 m-DEM thinned 5 m-DEM data RFi in the memory 190. In other words, the data illustrated in FIG. 8 is stored.

The 50 m-DEM thinned 5 m-DEM data RFi (not illustrated) is made up of the area Ei (number), the 50 m-mesh Mbi (number), the fine 5 m-mesh mbi included in the 50 m-mesh Mbi (number), latitude/longitude values (X, Y), the 5 m-DEM fine mesh points Paij, the interpolated elevation value zri of the points, clusters of points, and the like.

The interpolated elevation value zri of the fine 5 m-mesh mbi may be colored and displayed by the display processor 280.

As illustrated in FIG. 9, the bilinear-interpolated image GRi is still a coarse image (ridges are overemphasized, valleys are retracted too much, and contours are blurred). Therefore, a moving average process (also referred to as a smoothing process or smoothing) described below is performed.

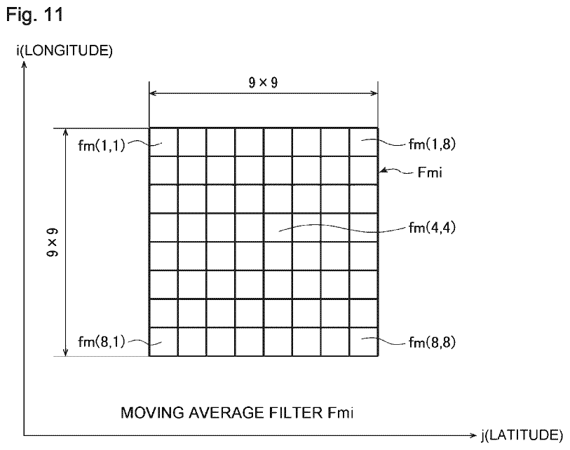

The moving average unit 210 sequentially designates the 50 m-DEM thinned 5 m-DEM data RFi in the memory 190, and for each designation, performs a moving average process (also referred to as a 9×9 box average process) of smoothing the interpolated elevation value zri by applying a 9×9 moving average mesh Fmi (also referred to as a moving average filter) illustrated in FIG. 11 a predetermined number of times to the fine 5 m-mesh mbi.

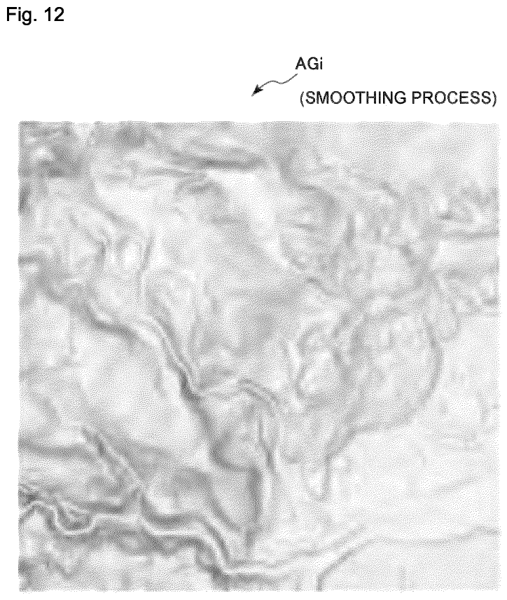

The “50 m-DEM thinned 5 m-DEM smoothed and blurred image AGi” (refer to FIG. 12) after the moving average process is colored and displayed by the display processor 280 (however, imaging of slope gradients). Note that the “50 m-DEM thinned 5 m-DEM smoothed and blurred image AGi” in FIG. 12 is an image obtained by repeating moving average twice. The image (AGi) is an image obtained by the red stereoscopic image generation process (not illustrated).

Data of the “50 m-DEM thinned 5 m-DEM smoothed and blurred image AGi” will be referred to as “blurred 5 m-DEM smoothed data hgi”. The pieces of data are stored in a memory 240.

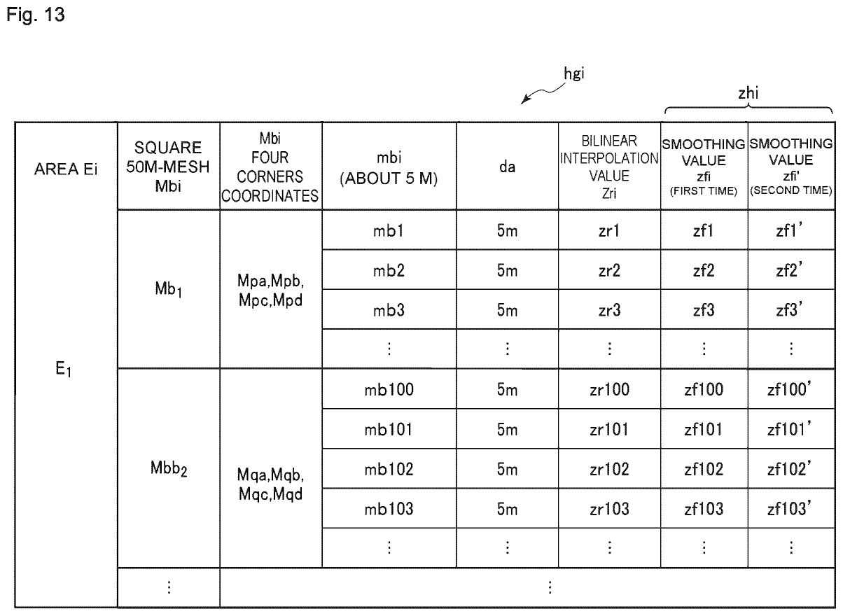

As illustrated in FIG. 13, the “blurred 5 m-DEM smoothed data hgi” is made up of the area Ei (number), the 50 m-mesh Mbi (number), coordinates (Mpa, Mpb, Mpc, Mpd) of the four corners of the 50 m-mesh Mbi, the fine 5 m-mesh mbi (number) included in the 50 m-mesh Mbi, the division width da (approximately 5 m), the bilinear interpolation value (zri), the smoothing elevation value zfi (first time), the smoothing elevation value zfi′ (second time), and the like.

Note that zfi (first time) and the smoothing elevation value zfi′, . . . will be collectively referred to as a “smoothing elevation value zhi”.

The numbers of meshes (size equivalent to 5 m: 0.2 seconds) that constitute the moving average mesh Fmi described earlier is described as fmi [(fm1, 1), (fm1, 2), . . . (fm8, 8)] in FIG. 11.

The blurred 5 m-DEM smooth red stereoscopic image generator 250 performs a red stereoscopic visualization process (“blurred” stereoscopic visualization process) using the “blurred 5 m-DEM smoothed data hgi”.

In other words, for each 50 m-mesh Mbi in the “blurred 5 m-DEM smoothed data hgi”, mbi included in the 50 m-mesh Mbi is sequentially designated as a subject point, a slope gradient between the subject point and an mbi adjacent to the subject point is determined based on the smoothing elevation value zhi, and the determined slope gradient is assigned to the mbi of the subject point.

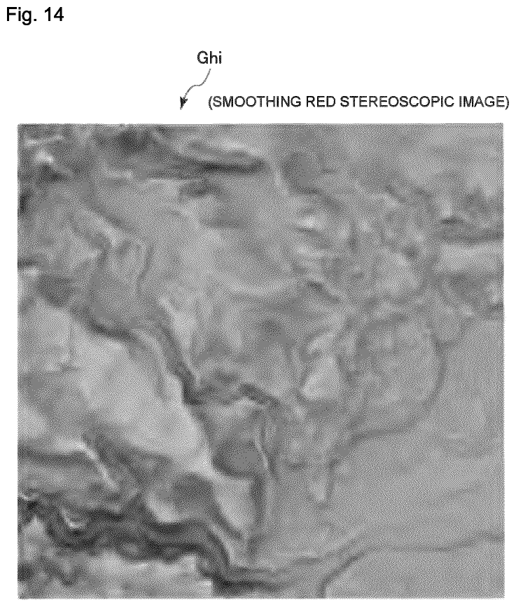

Then, for each subject point, a ridge-valley value (also referred to as an elevation-depression degree) between the subject point and an mbi adjacent to the subject point is determined, and data in which a gradation color value (also referred to as a gradation color) indicating a color value of a combination of the ridge-valley value and the slope gradient is assigned to the mbi of the subject point is generated in the memory 240 as the completed 5 m-mesh smooth red stereoscopic image GHi (refer to FIG. 14).

In addition, FIG. 14 illustrates the completed 5 m-mesh smooth red stereoscopic image GHi after a red stereoscopic imaging process to be described later. As illustrated in FIG. 14, the “completed 5 m-mesh smooth red stereoscopic image GHi” is still blurry and, while an overall shape is discernible, unevenness is also blurry. Therefore, multiply synthesis to be described later is performed.

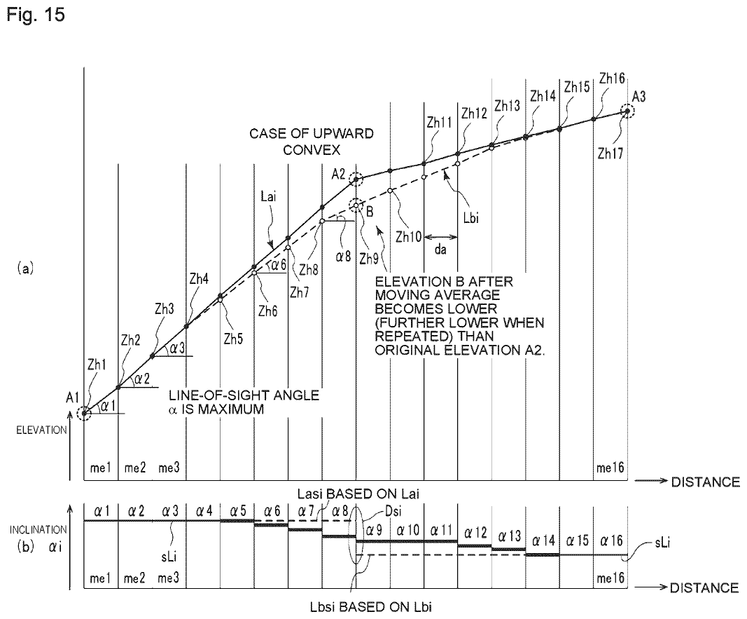

A processing of assigning a slope gradient to an mbi will now be described with reference to FIG. 15. However, the mbi will be described as a moving average fine mesh mei. In addition, a ridge-valley value (over-ground openness, under-ground openness) will be described later.

Next, slope gradients between the smoothing elevation values zhi of the moving average fine meshes mei and the smoothing elevation value zhi of each moving average fine mesh mei adjacent in the four directions are determined, and an average slope gradient (hereinafter, referred to as a slope gradient ai) of the slope gradients is associated with the designated moving average mesh mei.

In other words, the slope gradient ai is associated with the “blurred 5 m-DEM smoothed data hgi”.

This process is performed for each of all moving average fine meshes mei.

Mapping the slope gradient αi (α1, α2, . . . ) to a distance axis produces a result illustrated in FIG. 15(b).

A solid line in FIG. 15(b) is referred to as an average slope gradient plot line SLi (solid line).

As illustrated in FIG. 15(a), the smoothing elevation value zhi of the moving average fine meshes me1, me2, me3, and me4 between A1 and A2 increases at an approximately constant rate from zh1 to zh5.

Therefore, as illustrated in FIG. 15(b), there is no change to average slope gradients α1, α2, α3, and α4 of me1, me2, me3, and me4 between A1 and A2.

However, as illustrated in FIG. 15(a), heights of me5, me6, me7, and me8 between A1 and A2 gradually increase from zh5 to zh9.

Therefore, as illustrated in FIG. 15(b), average slope gradients α5, α6, α7, and α8 of me5, me6, me7, and me8 gradually decrease.

However, as illustrated in FIG. 15(a), heights of me9, me10, me11, and me13 between A2 and A3 smoothly increase from zh9 to zh14.

Therefore, as illustrated in FIG. 15(b), average slope gradients α9, . . . , α13 of me9, me10, me11, and me13 are also trending slightly downward.

The important point here is that, as illustrated in FIG. 15(b), plotting the slope gradient of Lai when moving average (super-resolution smoothing process) is not performed to FIG. 15(b) results in a dotted line Lsai between A1 and A2 (me1 to me8) (covers a solid line between me1 and me5).

In addition, between A2 and A3 (me9 and me16), an abrupt downward change occurs and results in a dotted line Lsbi (covered by a solid line between me14 and me16). The change location is described as Dsi.

However, in the present embodiment, because moving average (super-resolution smoothing process) is performed, the Dsi location does not change abruptly and resembles the average slope gradient plot line SLi (solid line). Therefore, no jaggies occur.

The color value of the slope gradient and the color value of the ridge-valley value obtained as described above are synthesized to obtain the “completed 5 m-mesh smooth red stereoscopic image GHi” (refer to FIG. 14).

The multiply synthesizer 220 synthesizes, by multiplication, a 5 m-DEM red stereoscopic map image Ki (red stereoscopic image data Kmi) to be described later in a memory 130 (layer) and the “completed 5 m-mesh smooth red stereoscopic image GHi” in the memory 240 (layer), and stores multiply-synthesized image data KHi in a memory 230.

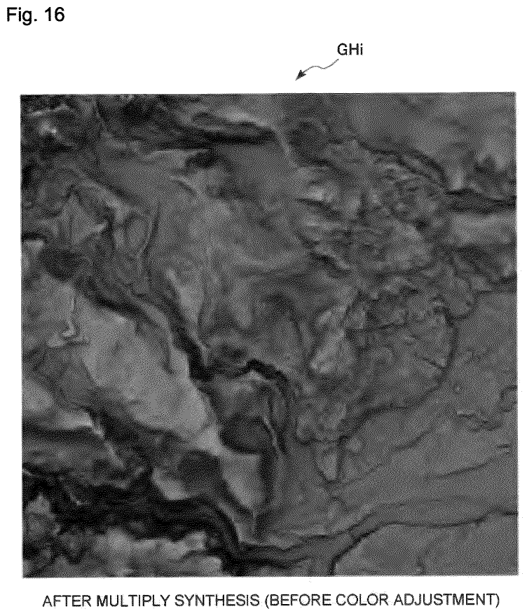

FIG. 16 represents an image (referred to as a multiply-synthesized red stereoscopic visualization image GHi) of the multiply-synthesized image data KHi (before color adjustment). Since the multiply-synthesized red stereoscopic visualization image GHi in FIG. 16 is before color adjustment, the image is slightly dark.

However, the multiply-synthesized red stereoscopic visualization image GHi has no jaggies, large terrain appears to protrude, and fine terrain is discernible in detail.

Next, processing by the red stereoscopic image generator 120 will be described.

The red stereoscopic image generator 120 sequentially designates 5 m-meshes Mai of the base map (5 m-DEM) in the memory 110 and, for each designation, performs a red stereoscopic image generation process (stereoscopic visualization image process).

The red stereoscopic image generation process uses the techniques described in Japanese Patent No. 3670274. Since the blurred 5 m-DEM smooth red stereoscopic image generator 250 is a similar concept, the red stereoscopic image generator 120 will be described as a representative. The process is also referred to as a red stereoscopic image generation process.

An outline thereof will be described.

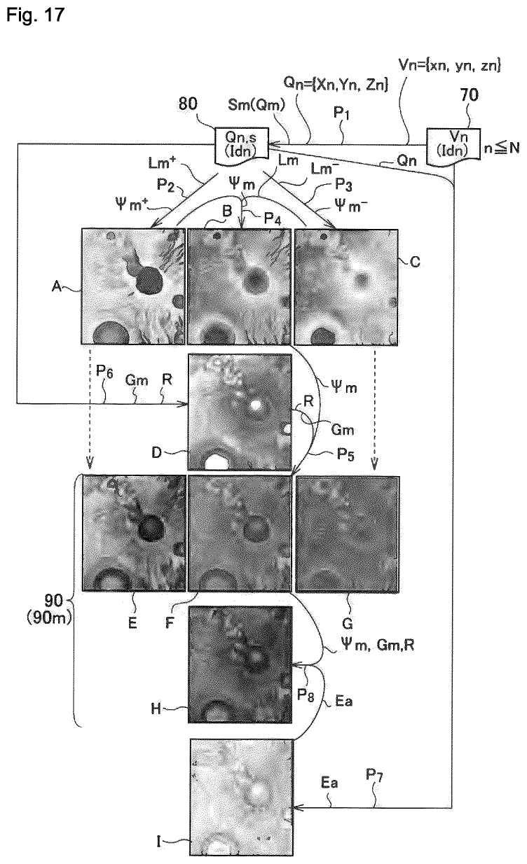

As illustrated in FIG. 17, from an identification number Idn and an altitude difference of a n-th (n=1 to N)-processed two-component vector Vn, a longitude xn, a latitude yn, and a sea level altitude zn are calculated, and the values are mapped to corresponding coordinate points Qn={Xn=xn, Yn=yn, Zn=zn} in a virtual three-dimensional (3D) X-Y-Z Cartesian three-dimensional coordinate space 80 stored in a memory (not illustrated).

In other words, by storing the identification number Idn of the vector Vn in a storage region corresponding to the coordinate point Qn in the memory, the vector Vn is mapped to the three-dimensional coordinate space 80, and by executing such mapping on a total of N-number of vectors, a vector field 70 is mapped to the three-dimensional coordinate space 80 (process P1).

Furthermore, a curved surface S for connecting a sequence of the total number N or an appropriate number less than N of the coordinate points with Id {Qn: n≤N} in the three-dimensional coordinate space 80 with a required smoothness is obtained by a least-square method or the like, the curved surface S is divided into minute surface areas {Sm: m≤M} of a total number M {M≤N}, respective subject sampling-points Qm are determined, and related information is stored in a memory.

Then, with respect to each surface area Sm, a local area Lm+ on an over-side (Z+ side) of the curved surface S located within a predetermined radius from the subject sampling-point Qm is determined, and an openness (that is, a line-of-sight solid angle with respect to the sky side or a twice derivative value equivalent to the line-of-sight solid angle) Ψm+ around the subject sampling-point Qm defined by the local area Lm+ is obtained (process P2). And the obtained openness is stored as an elevation degree of the surface region Sm.

A resulted image, which represents the elevation degree Ψm+ in a gradation over the entire curved surface S, is defined as a “process-result A” ascribable to a result of the above processing. The image A clearly represents a ridge side of the terrain, that is, a convex portion (of the curved surface S) so as to look like a convexity.

Then, with respect to the surface area Sm, a local region Lm− on a under-side (Z− side) of the curved surface S located within the predetermined radius from the subject sampling-point Qm is determined, and an openness (that is, a line-of-sight solid angle with respect to the ground side or a twice derivative value equivalent to the line-of-sight solid angle) Ψm− around the subject sampling-point Qm defined by the local area Lm− is obtained (process P3). And the obtained openness is stored as a depression degree of the surface region Sm. A resulted image, which represents the depression degree Ψm− in a gradation over the entire curved surface S, is defined as a “process-result C” ascribable to a result of the above processing.

The image C clearly represents a valley side of the terrain, that is, a concave portion (of the curved surface S) so as to look like a concavity.

It should be noted that the image C does not result in a simple inversion of the image A.

Then, with respect to the surface area Sm, the elevation degree Ψm⁺ and the depression degree Ψm⁻ are synthesized by weighting using a distribution ratio w⁺: w⁻ (w⁺+w⁻=0) as (w⁺Ψm⁺+w⁻Ψm⁻), which is appropriately determined (in other words, according to whether to focus on the ridge or the valley). Then, a stereoscopic effect that the local area Lm (Lm+, Lm−) on the over-side and the under-side of the curved surface S located within the predetermined radius brings around the subject sampling-point Qm is determined (process P4), and the stereoscopic effect is stored as an elevation-depression degree Ψm of the surface area Sm.

A resulted image, which represents the elevation-depression degree Ψm in a gradation over the entire curved surface S, is defined as a “process-result B” ascribable to a result of the above processing. The image B clearly represents the convexity portion (of the curved surface S) as a convexity and the concave portion as a concavity, whereby the ridges and valleys of the terrain are accentuated to enhance the visual stereoscopic effect. In the image B, the weight of the synthesis is w⁺=−w⁻=1.

Then, regarding the surface region Sm, a maximum slope gradient (or a single derivative value equivalent to the maximum slope) Gm is obtained directly or indirectly through the least-square method (process P6), and stored as a slope gradient Gm of the surface area Sm.

An achromatic color image, which represents the slope gradient Gm in color tone with a reddish color R over the entire curved surface S, is defined as a “process-result D” ascribable to a result of the above processing. The image D also has an effectiveness of visually developing a stereoscopic effect on the terrain (that is, the curved surface S).

Then, by mapping the three-dimensional coordinate space 80 together with the related information (Ψm, Gm, R) onto a two-dimensional plane 90 (process P5), the R-color tone display of the slope gradient Gm is executed in an area 90 m on the two-dimensional plane 90 corresponding to the divided area Sm of the surface S connecting the sequence of the coordinate points Qm, and the brightness of the R-color tone is displayed in a gradation corresponding to the elevation-depression degree Ψm.

The displayed image (displayed image in an achromatic color) is defined as a “process-result F” ascribable to a result of the above processing. The image F imparts the visual stereoscopic effect to the terrain (that is, the curved surface S).

An image E represents a result of mapping process (process P5) of the information of the image D (that is, the R-color tone indicating the slope gradient Gm) and the information of the elevation-depression degree (that is, the elevation degree Ψm⁺) corresponding to the image A onto the two-dimensional plane 90, and the ridge portion is emphasized.

An image G represents a result of mapping process (process P5) of the information of the image D (the R-color tone indicating the slope gradient Gm) and the information of the elevation-depression degree (that is, the depression degree Ψm−), which corresponds to the image C, onto the two-dimensional plane 90, and the valley portion is emphasized.

In the sequences of the coordinate points Qn, an attribute isoline Ea (contour and outline of the terrain in the present embodiment) obtained by connecting the coordinate points Qn having an equivalent value in the attribute (altitude zn in the present embodiment) extracted from the component of the vector Vn of the vector field 70 is determined. The attribute isoline Ea is stored to read out or display as necessary (process P7).

A process-result I also contributes to understanding the three-dimensional shape of the terrain (or the curved surface S).

Then, on the two-dimensional plane 90, the three-dimensional coordinate space 80 is mapped or displayed together with the relevant information (Ψm, Gm, R), and the attribute isoline Ea is mapped or displayed (process P8). The displayed image (of the achromatic display image) is defined as a “process-result H” ascribable to a result of the above processing. The image H also imparts a visual stereoscopic effect to the terrain (that is, the curved surface S).

Accordingly, the generation scheme of the red stereoscopic image includes a second step, after executing a first step (61) of mapping a vector field (70) into a three-dimensional coordinate space (80) to obtain a corresponding coordinate point sequence. The second step determines an openness around a subject sampling-point defined by an over-side of an area located within a predetermined radius of the subject sampling-point in a local area of a surface connecting the coordinate point sequence as an elevation degree (elevation-depression degree) (A) of the local area.

The generation scheme further includes a third step of determining an openness around the subject sampling-point defined by an under-side of the area located within the predetermined radius of the subject sampling-point in the local area of the surface connecting the coordinate point sequence as a depression degree (C) of the local area, and

a fourth step of synthesizing the elevation degree (A) and the depression degree (C) by weighting to determine an openness that the areas of the over-side and the under-side in the predetermined radius bring around the subject sampling-point in the local area of the surface connecting the coordinate point sequence as an elevation-depression degree (B) of the local area.

The generation scheme still further includes a fifth step of mapping the three-dimensional coordinate space (80) onto a two-dimensional plane (90), and executing a gradation display (F) corresponding to the elevation-depression degree of the local area on an area on the two-dimensional plane (90) corresponding to the local area of the surface connecting the coordinate point sequence.

Next, a more specific description will be given below. On the basis of Digital Elevation Model (DEM) data, triple parameters of a slope gradient corresponding to the slope gradient Gm, an over-ground openness corresponding to the elevation degree Ψm⁺ of the first embodiment, and an under-ground openness corresponding to the depression degree Ψm− of the first embodiment are obtained, and distributions of the triple parameters in a plane are stored as gray scale images.

Portions of the ridge and the crest are rendered as white-like, portions of the valley and the hollow are rendered as black-like, and the portions of slopes are rendered more redder, as the slope becomes steeper and steeper, by creating a pseudo-color image. The pseudo-color image is created by putting the difference image of the over-ground openness and the under-ground openness into a gray channel, and by putting the slope into a red channel. Therefore, even a single sheet of image facilitates the stereoscopic effect, by combining such expressions of rendering white, black, and red.

In other words, in a stereoscopic representation method of a stereoscopic map according to the present embodiment, because the meshes are provided between the contours, the difference or the inclination between the adjacent meshes can be represented by a red color tone, and furthermore, the difference of the elevation compared to the surrounding can be represented by a tone of gray scale. The difference of the elevation corresponds to the elevation-depression degree Ψm and is provided with the ridge-valley value in the present embodiment. The difference of the elevation is suggested in that the brighter one is higher than the surrounding (ridge-like) and the darker one is lower than the surrounding (valley-like), and therefore, the stereoscopic effect is generated by multiply synthesis of the contrasting.

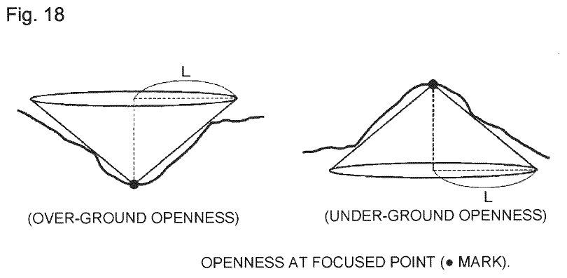

In other words, in the present embodiment, the concept of openness is used. The openness manifests a quantified degree of the extent to which the relevant spot protrudes over the ground and penetrates under the ground compared to the surrounding area. That is, as illustrated in FIG. 18, the over-ground openness represents an extent of the sky to be seen, within a range of a consideration distance L from a subject sampling-point. And the under-ground openness represents an extent of the under-ground, within a range of the consideration distance L, when taking a survey in the soil in a handstand position.

The openness depends on the consideration distance L and the surrounding terrain. In general, the over-ground openness increases as the point protrudes higher from the surrounding and has larger values at the crest and ridge, and has smaller values at the hollow and the bottom of valley. On the other hand, the under-ground openness increases as the point penetrates under the ground and has larger values at the hollow and the bottom of valley, and has smaller values at the crest and the ridge.

That is, terrain cross sections are generated for each of octuple directions on meshes included in a range of a certain distance (consideration distance L: the same consideration distance applies to the smooth red stereoscopic image generator 250) from the subject sampling-point, and a maximum value (when viewed from the vertical direction) among inclinations of the lines connecting respective terrain points and the subject sampling-point is determined. Such processing of generating terrain cross sections and determining the maximum value is executed in each of the octuple directions.

In addition, terrain cross sections are generated in each of octuple directions within a range from the subject sampling-point of the smoothing fine elevation value of the inverted super-resolution fine mesh, and a maximum value (a minimum value when L2 (not illustrated) is viewed from the vertical direction in a three-dimensional view of the ground surface) among inclinations of the lines connecting respective terrain points and the subject sampling-point is determined.

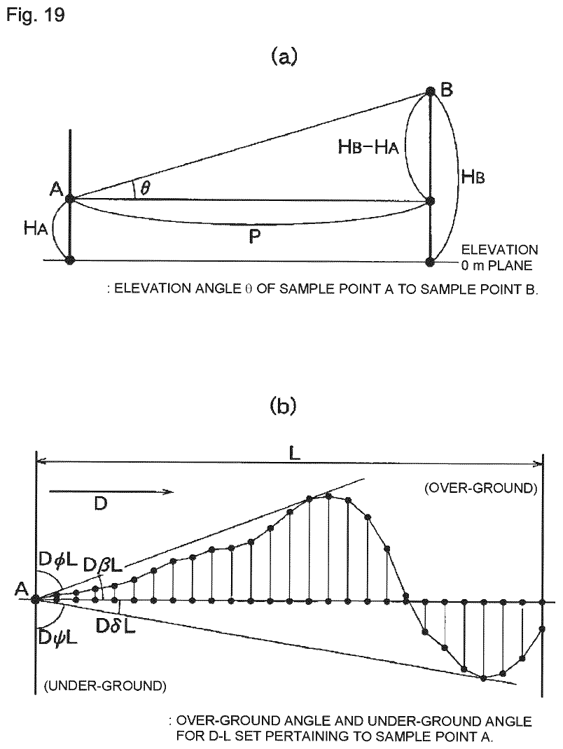

Such processing of generating terrain cross sections and determining the maximum value is executed in each of the octuple directions. In other words, as illustrated in FIG. 19, in the over-ground openness and the under-ground openness, two sampling points A (iA, jA, HA) and B (iB, jB, HB) are supposed. Because the sample interval is approximately 5 cm, the distance between A and B is given by

P=[(iA−iB)²+(jA−jB)²]^{1/2} (1).

FIG. 19 illustrates the relationship between the sampling point A and the sampling point B with respect to the elevation of 0 m.

The elevation angle θ at the sampling point A with respect to the sampling point B is given by θ=tan−1{(HB−HA)/P}. The sign of θ is: (1) positive in the case of HA<HB and (2) negative in the case of HA>HB.

Hereinafter, a set of sampling points residing in an azimuth D within a range of the consideration distance L from a subject sampling-point will be described as a DSL.

And, furthermore, the DSL will be referred to as “a D-L set of the subject sampling-points”. Here, DβL and DδL are provided as below:
DβL: a maximum value among the elevation angles for respective elements of the DSL pertaining to the subject sampling-point, and
DδL: a minimum value among the elevation angles for respective elements of the DSL pertaining to the subject sampling-point (see FIGS. 19(a) and (b)).

Then, the following definition is given.

Definition 1: an over-ground angle and an under-ground angle for the D-L set pertaining to the subject sampling-point shall denote respectively as:

$$D φ L = 90 - D β L ,$$

$$and$$

$$D Ψ L = 90 + D δ L .$$

DφL means a maximum value of a zenith angle in which the sky in the azimuth D can be seen within the consideration distance L from the subject sampling-point. The generally referred horizon angle corresponds to the ground angle, when the distance L is infinity. Further, DΨL means a maximum value of the nadir angle in which the soil in the azimuth D can be seen within the consideration distance L from the subject sampling-point. As the distance L increases, the number of sampling points belonging to the DSL increases, and thus, DβL has a non-decreasing property and DOL has a non-increasing property.

Therefore, both DφL and DΨL have non-increasing properties for L.

A high angle in academical term of land surveying is a concept defined with reference to a horizontal plane passing through the subject sampling-point, and not strictly coincident with θ. In addition, for strict discussion of the over-ground angle and the under-ground angle, the curvature of the Earth should also be considered. And therefore, Definition 1 is not necessarily an accurate description. Definition 1 is a concept defined doggedly on the premise of carrying out topographic analysis using the DEM scheme.

The over-ground angle and the under-ground angle are the concepts of the specified azimuth D, but a following definition is introduced as an extension of the above-mentioned concept.

Definition II: the over-ground openness and the under-ground openness for the consideration distance L pertaining to the subject sampling-point are respectively defined as:

$$φ L = ( 0 φ L + 45 φ L + 90 φ L + 135 φ L + 180 φ L + 225 φ L + 270 φ L + 325 φ L ) / 8 ,$$

$$and$$

$$Ψ L = ( 0 Ψ L + 45 Ψ L + 90 Ψ L + 1 \; 35 Ψ L + 1 \; 80 Ψ L + 2 \; 25 Ψ L + 2 \; 70 Ψ L + 3 \; 25 Ψ L ) / 8.$$

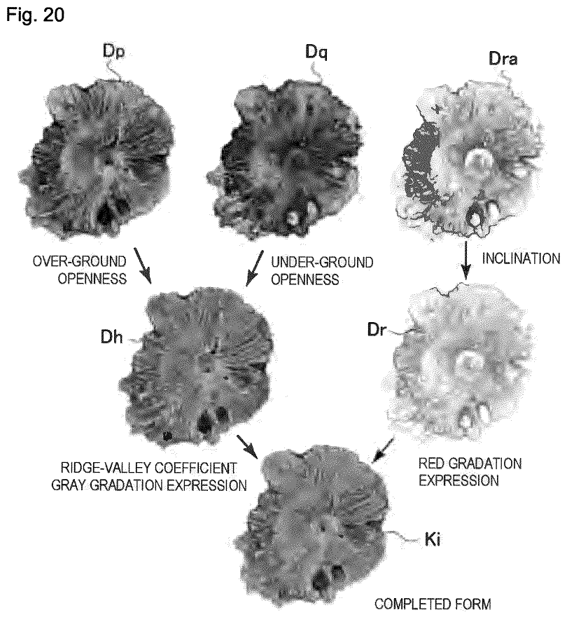

In other words, as illustrated in FIG. 20, a synthesized image Dh is generated by multiplying and synthesizing over-ground openness image data Dp (white emphasized on the ridge) and under-ground openness image data Dq (dark emphasized on the bottom). The slope-gradient emphasis image Dr in which red is emphasized as the slope gradient increases, and the synthesized image Dh are synthesized.

In other words, as illustrated in FIG. 20, a synthesized image of a gray gradation expression is obtained. Note that the expression “layer” is described as a layer because it is an image that is synthesized with other images.

In other words, the 5 m-DEM red stereoscopic map image Ki which is created by synthesizing the slope-gradient emphasis image Dr and the synthesized image Dh in a file and in which ridges are emphasized by red is obtained and displayed on the display.

Therefore, even a single sheet of image that facilitates the stereoscopic effect can be generated by combining such expressions. This allows a degree of elevation of unevenness and a degree of inclination to be comprehended at a glance.

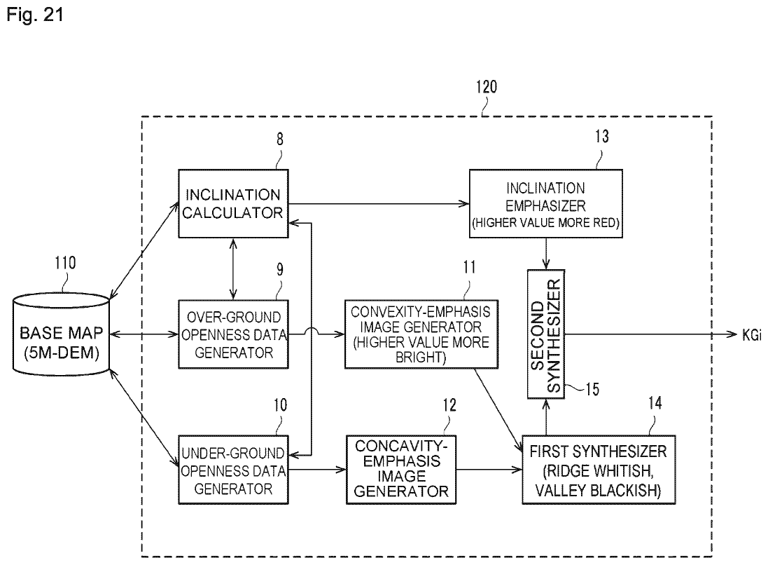

FIG. 21 is a block diagram of a program of the red stereoscopic image generator 120.

As illustrated in FIG. 21, the red stereoscopic image generator 120 includes an over-ground openness data generator 9, an under-ground openness data generator 10, and an inclination calculator 8. The super-resolution image generator 151 further includes a convexity-emphasis image generator 11, a concavity-emphasis image generator 12, an inclination emphasizer 13, a first synthesizer 14, and a second synthesizer 15.

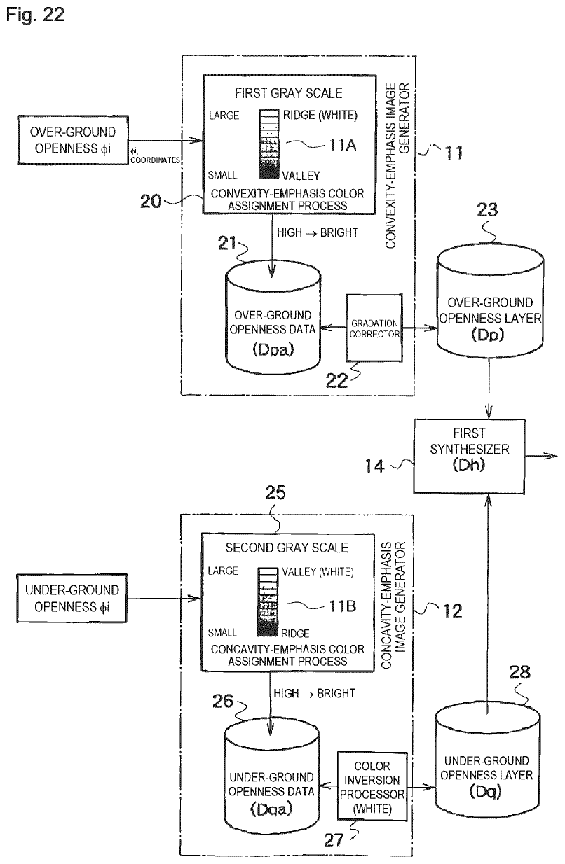

FIG. 22 is a schematic configuration diagram explaining the convexity-emphasis image generator 11 and the concavity-emphasis image generator 12. However, the first synthesizer 14 and the like are illustrated in FIG. 22.

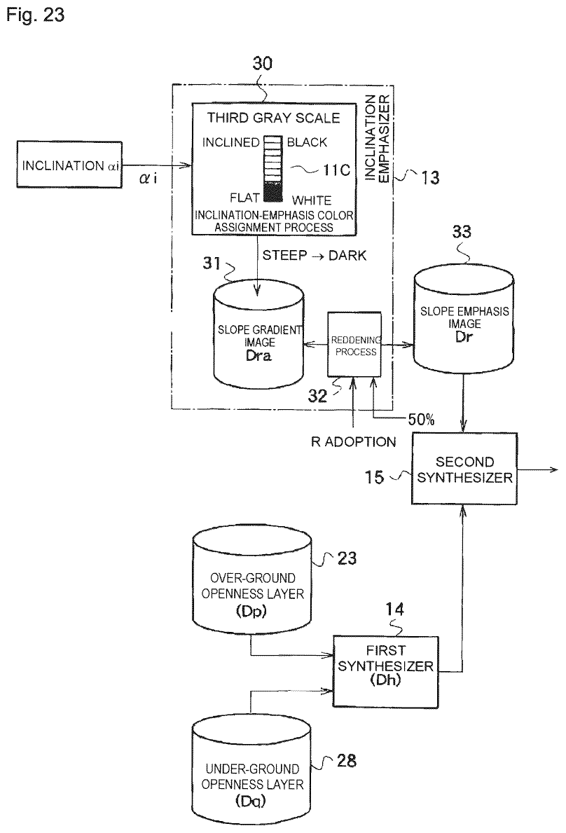

FIG. 23 is a schematic configuration diagram explaining the inclination emphasizer 13. However, the first synthesizer 14, the second synthesizer 15, and the like are illustrated in FIG. 23.

Before describing the above, the description of the inclination calculator 8 will be supplemented.

The inclination calculator 8 obtains an average inclination (slope gradient) of each plane of squares adjacent to the subject point of the 5 m-mesh Mai in the memory 110. The average inclination (referred to as the slope gradient αi) is an inclination of a surface approximated from quadruple points using the least-square method.

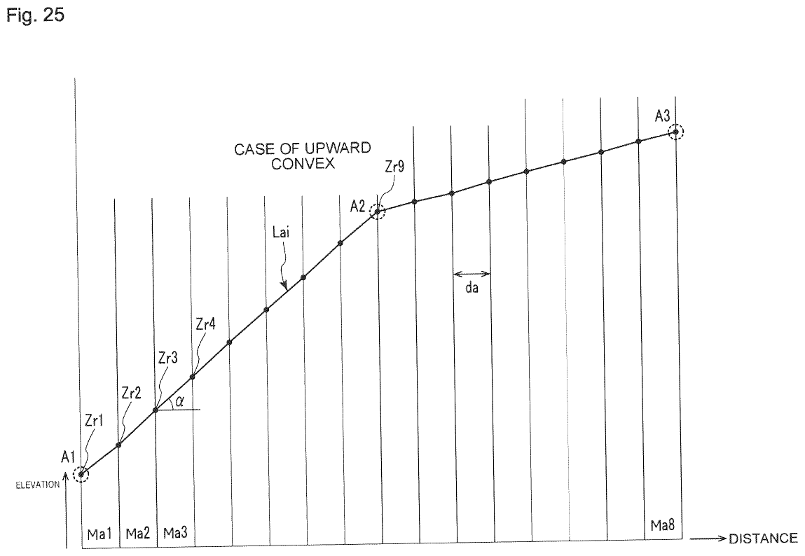

FIG. 25 illustrates a diagram in which the slope gradient αi is associated with a distance value. Since a moving average is not performed (curvature maximization process: spline curve, Bezier curve, or the like is performed), if the elevation value zri is associated with each interval of the 5 m-mesh Mai (Ma1, Ma2, . . . ), for example, a trajectory connecting a point A1, a vertex A2, and a point A3 becomes a straight line Lai (depicted by a solid line).

In addition, an average slope gradient (slope gradient αi) in each of the four adjacent directions relative to the subject point (5 m-mesh Mai) is described.

The over-ground openness data generator 9 generates terrain cross sections for each of octuple directions on the 5 m-mesh Mai included in a range of a certain distance (consideration distance L) from the subject sampling-point. And the over-ground openness data generator 9 determines a maximum value (when viewed from the vertical direction) among inclinations of the lines connecting respective terrain points and the subject sampling-point. Such processing of generating terrain cross sections and determining the maximum value is executed in each of the octuple directions.

In addition, the under-ground openness data generator 10 generates the terrain cross sections in each of octuple directions within a range from the subject sampling-point of the inverted 5 m mesh Mai to the certain distance. And the under-ground openness data generator 10 determines a maximum value (a minimum value when L2 (not illustrated) is viewed from the vertical direction in a three-dimensional view of the ground surface) among inclinations of the lines connecting respective terrain points and the subject sampling-point. Such processing of generating terrain cross sections and determining the maximum value is executed in each of the octuple directions.

The convexity-emphasis image generator 11 includes a convexity-emphasis color assignment process 20 as illustrated in FIG. 22.

As illustrated in FIG. 22, the convexity-emphasis color assignment process 20 includes the first gray scale 11A for expressing the ridge and the bottom of valley by brightness. Brightness (luminance) corresponding to a value of the over-ground openness Ψi is calculated every time the over-ground openness data generator 9 obtains the over-ground openness Ψi (an average angle when viewing the range of the distance L from the subject point in octuple directions: an index for determining whether the residing point is at a high position).

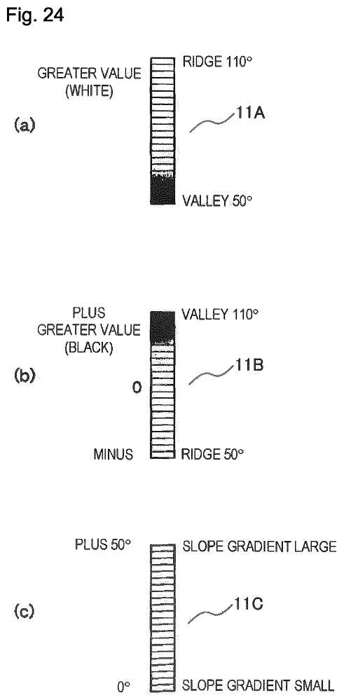

For example, when a value of the over-ground openness falls within a range of about 40 degrees to 120 degrees, the first gray scale 11A is associated with a range of 50 degrees to 110 degrees, which is assigned to 255 gradations (see FIG. 24(a)).

In other words, the greater the value of the over-ground openness as the portion of the ridge (convex portion), the whiter the color.

In addition, the convexity-emphasis color assignment process 20 of the convexity-emphasis image generator 11 reads over-ground openness image data Da, applies meshing by squares to contours connecting meshes of the same Z-value as the 5 m-mesh having the subject point (coordinates), assigns color data based on the first gray scale 11A when one of the four corners of the mesh is adopted as the subject point (refer to FIG. 24), and stores the color data in an over-ground openness file 21 (over-ground openness image data Dpa).

On the other hand, the gradation corrector 22 of the convexity-emphasis image generator 11 stores, in a memory 23, the over-ground openness layer Dp in which the color gradation of the over-ground openness image data Dpa is inverted. That is, the over-ground openness layer Dp adjusted the ridge to be whiter is obtained.

The concavity-emphasis image generator 12 includes a concavity-emphasis color assignment process 25 as illustrated in FIG. 22. The concavity-emphasis color assignment process 25 includes the second gray scale 11B (see FIG. 24(b)) for expressing the bottom of valley and ridge by brightness. Brightness corresponding to a value of the under-ground openness Ψbi is calculated every time the under-ground openness data generator 10 obtains the under-ground openness bi (an average of octuple directions from the subject point).

For example, when a value of the under-ground openness falls within a range of about 40 degrees to 120 degrees, the second gray scale 11B is associated with a range of 50 degrees to 110 degrees (see FIG. 24(b)), which is assigned to 255 gradations.

That is, since the value of the under-ground openness has the larger value in the portion of the bottom of valley (concavity), the color becomes darker.

Then, as illustrated in FIG. 22, the concavity-emphasis image generator 12 reads under-ground openness image data Db, assigns color data based on the second gray scale 11B with the same Z-value as the subject point, and stores the color data in an under-ground openness file 26. Next, the color inversion processor 27 corrects the color gradation of the under-ground openness image data Db and stores the color gradation in a memory 28 (layer).

When the color becomes too dark, the color is set to the degree of correction of the tone curve. The layer is stored as an under-ground openness layer Dq.

The inclination emphasizer 13 includes an inclination-emphasis color assignment process 30 as illustrated in FIG. 23.

The inclination-emphasis color assignment process 30 includes a third gray scale 11C for expressing the degree of inclination in accordance with the degree of brightness (see FIG. 24(c)), and every time the inclination calculator 8 obtains the slope gradient (average in quadruple directions from the subject point), the brightness (luminance) of the third gray scale 11C corresponding to the value of the slope gradient is calculated.

For example, when the value of the slope gradient αi falls within a range of about 0 degree to 70 degrees, the third gray scale 11C is associated with a range of 0 degree to 50 degrees, which is assigned to 255 gradations. That is, 0 degree is white, and equal to or more than 50 degrees is black. The larger the slope gradient αi, the darker the color.

Then, as illustrated in FIG. 22, the inclination-emphasis color assignment process 30 of the inclination emphasizer 13 stores a difference image between the under-ground openness image data Db and the over-ground openness image data Da as a slope gradient image Dra in a memory 31.

In doing so, color data based on the third gray scale 11C is assigned to a mesh with the same Z-value as the subject point (coordinates).

Next, a reddening process 32 emphasizes R by an RGB color mode function (however, sometimes 50 percent emphasis may be used). That is, the slope-gradient emphasis image Dr in which the steeper the slope, the more the red is emphasized is stored in a memory 33 (layer).

The first synthesizer 14 obtains a synthesized image Dh synthesized by multiplying the over-ground openness layer Dp and the under-ground openness layer Dq. At the same time, the balance of both images Dp and Dq is adjusted so as to avoid collapsing the valley part.

The “multiply” described above is a term used in Photoshop (registered trademark) for a layer mode and is an OR operation in numerical processing.

For example, a subdued red color provided with a hue of zero degree, a chroma saturation of 50%, and a brightness of 80%.

When each color value of RGB is specified in the range of 0 to 255, RED is set to “204”, GREEN is set to “102”, and BLUE is set to “102”. The HEX value (WEB color in hexadecimal/HTML color code) is set to #CC6666. Alternatively, the CMYK values used for color printing are approximately set to cyan “C 20%”, magenta “M 70%”, yellow “Y 50%” and black “K 0%”.

The image, which is reduced in the color value by 50%, will be referred to as a red stereoscopic visualization image Gai′.

The second synthesizer 15 synthesizes the slope-gradient emphasis image Dr in which red is emphasized as the slope gradient increases and the synthesized image Dh obtained by synthesizing the over-ground openness layer Dp and the under-ground openness layer Dq by multiplication, and causes the display processor 280 to display the 5 m-DEM red stereoscopic map image Ki

In other words, the memory 130 stores, as red stereoscopic image data Kmi (not illustrated), the area Ei (number), the 5 m-mesh Mai (number), zri, the slope gradient αi, the color value of the slope gradient, the color value of the elevation-depression degree (not illustrated: over-ground openness, under-ground openness), and the like.

The multiply synthesizer 220 performs multiply synthesis of necessary data (color values) between the red stereoscopic image data Kmi [area Ei (number), 5 m-mesh Mai (number), zri, slope gradient αi, color value of slope gradient da (5 m), color value of elevation-depression degree (not illustrated: over-ground openness, under-ground openness), and the like] and data of “completed 5 m-mesh smooth red stereoscopic image GHi” [area Ei (number), 50 m-mesh Mbi (number), coordinates of four corners of 50 m-mesh Mbi, fine 5 m-mesh mei (number) included in 50 m-mesh Mbi, division width da (approximately 5 m), bilinear interpolation value (zri), smoothing elevation value zhi, slope gradient, color value of slope gradient, elevation-depression degree (ridge-valley value), color value of elevation-depression degree, and the like] in the memory 240.

The red stereoscopic image data Kmi is also simply referred to as a 5 m-DEM red stereoscopic map image Ki.

In other words, the 5 m-DEM red stereoscopic map image Ki and the completed 5 m-mesh smooth red stereoscopic image GHi are synthesized by multiplication. The image obtained by multiply synthesis is also referred to as a tentative fractal stereoscopic image.

In other words, the multiply-synthesized image data KHi is made up of the red stereoscopic image data Kmi (5 m-DEM red stereoscopic map image Ki), data of the “completed 5 m-mesh smooth red stereoscopic image GHi”, a multiply synthesis value, a multiply-synthesized color value, and the like.

The fractal stereoscopic image generator 260 (also referred to as a fractal stereoscopic image completion unit) generates, in a memory 270, fractal red stereoscopic completed DEM data created by associating color values when viewed from a predetermined direction with respect to the multiply-synthesized image data KHi in the memory 230.

In the present embodiment, a cluster (set) of the fractal red stereoscopic completed DEM data is referred to as a fractal red stereoscopic completed DEM.

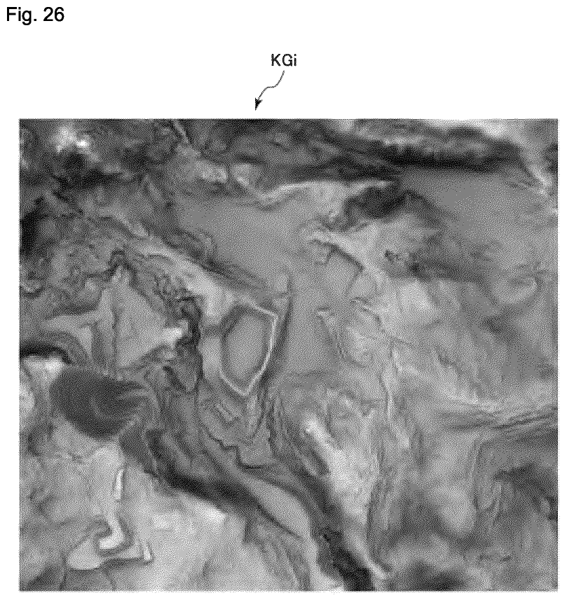

FIG. 26 illustrates a fractal terrain stereoscopic visualization image KGi representing the fractal red stereoscopic completed DEM being displayed on a screen by the display processor 280. FIG. 26 is a partial enlargement of FIG. 2.

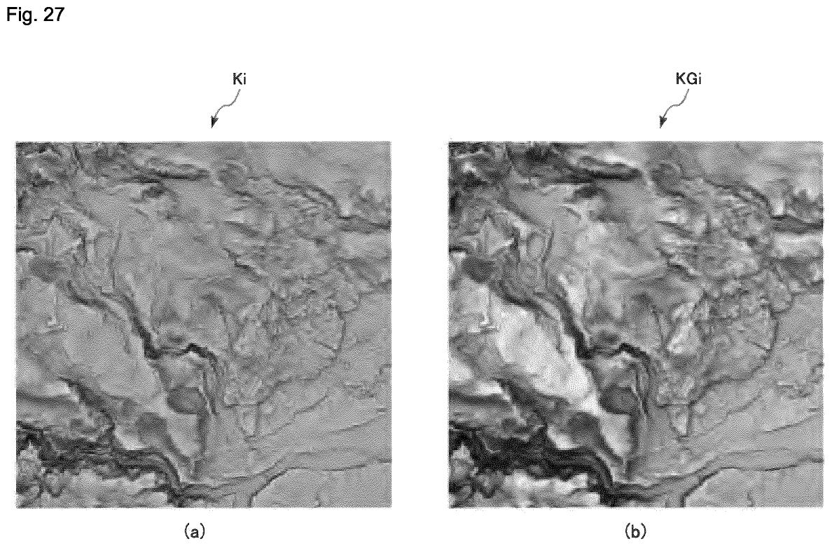

A red stereoscopic image and the fractal terrain stereoscopic visualization image KGi will be compared and described with reference to FIG. 27. FIG. 27(a) illustrates a general 5 m-DEM red stereoscopic map image Ki and FIG. 27(b) illustrates the fractal terrain stereoscopic visualization image KGi.

Comparing FIG. 27(a) with FIG. 27(b), FIG. 27(b) has a fractal terrain stereoscopic visualization image KGi that provides a greater stereoscopic effect in each step.

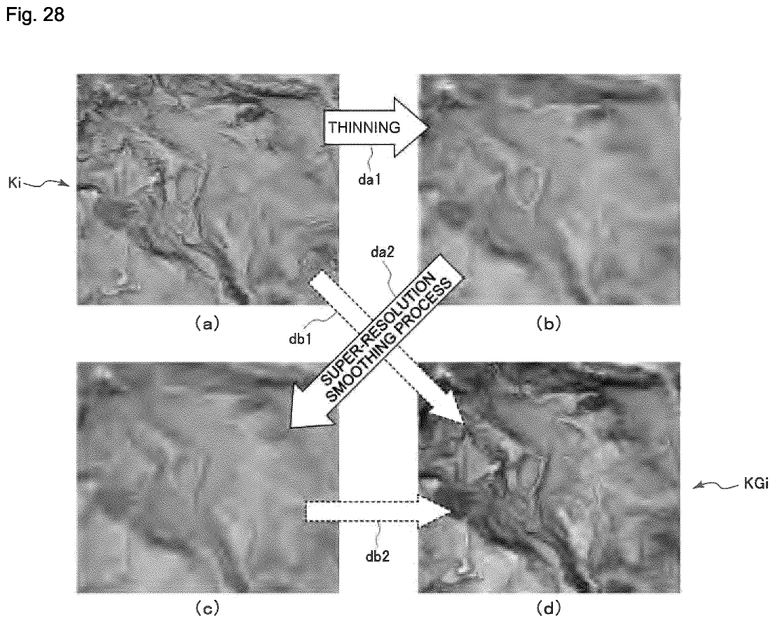

In other words, the present embodiment thins (da1) (1 in 10:5.555e-4) clusters of points of the 5 m-DEM red stereoscopic image DEM (5.555e-5) illustrated in FIG. 28(a), performs a conversion by thinning into a 50 m-DEM (refer to FIG. 28(b)), performs 10×10 bilinear interpolation and a 9×9 smoothing process (da2) with respect to the “50 m-DEM thinned to 5 m-DEM”, and obtains the completed 5 m-mesh smooth red stereoscopic image GHi illustrated in FIG. 28(c).

Then, the completed 5 m-mesh smooth red stereoscopic image GHi is read (db1), the 5 m-DEM red stereoscopic image DEM (5.555e-5) illustrated in FIG. 28(a) is read (db2), and the images are synthesized by multiplication (db1, db2) to obtain the fractal terrain stereoscopic visualization image KGi illustrated in FIG. 28(d).

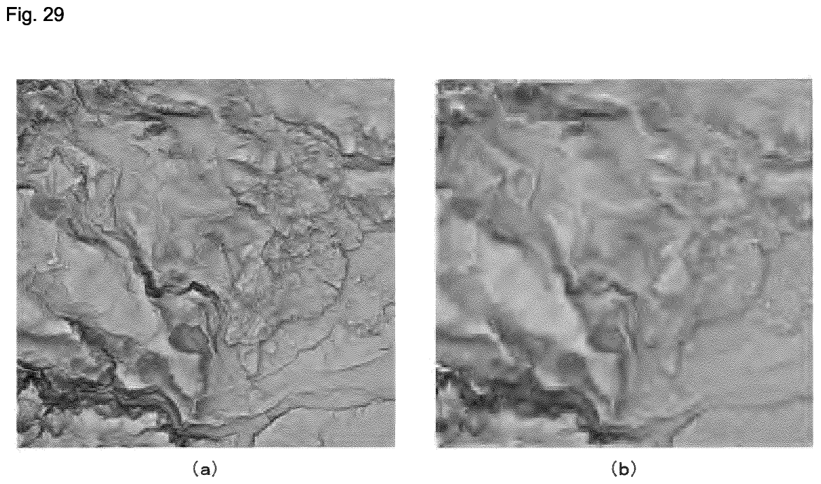

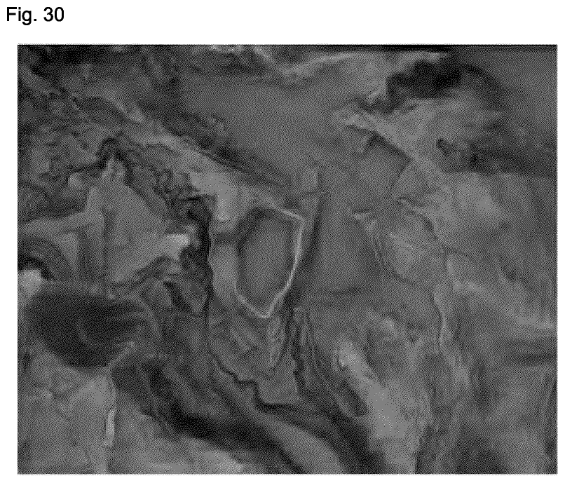

In other words, although simply synthesizing the general (also referred to as normal) 5 m-DEM red stereoscopic map image Ki illustrated in FIG. 29(a) and the 50 m-DEM red stereoscopic image illustrated in FIG. 29(b) by multiplication results in noticeable jaggies as shown in FIG. 30, by performing multiply synthesis with a general red stereoscopic image after the 10×10 bilinear interpolation and the 9×9 moving average process described above, the present embodiment is capable of producing an image without any jaggies, which can be processed quickly, and which provides a greater stereoscopic effect as shown in FIG. 2.

In other words, the fractal terrain stereoscopic visualization image KGi has improved visibility of both microtopography and large terrain.

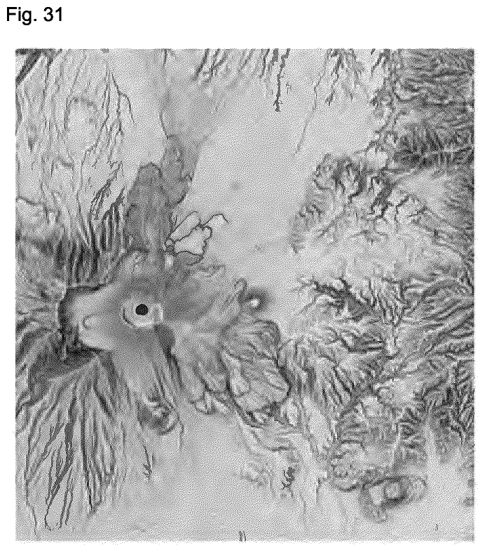

FIG. 31 is the fractal terrain stereoscopic visualization image KGi of Mount Asama. As illustrated in FIG. 31, Mount Asama, for example, appears to protrude spit out significantly more than the surrounding terrain. Looking down from a distance, a stereoscopic effect is noticeable, and looking up closer, greater detail and a stereoscopic effect are noticeable.

However, FIG. 31 represents an example of a multiply synthesis of a 50 cm-DEM and a 50 m-DEM. To convert the 50 cm-DEM to 50 m-DEM, the 50 cm-DEM is stored in a memory and subjected to two thinning processes by the 50 m-DEM thinning converter 160.

While the embodiment described above has been described using a DEM of ground above ground, a DEM of the seabed ground may be used instead.

In addition, visibility is greatly improved when printing on large floor carpets and when displaying large high-definition displays such as 8K.

Furthermore, the red stereoscopic image generator 120 and the blurred 5 m-DEM smooth red stereoscopic image generator 250 may include an X-direction adjuster (not illustrated).

The X-direction adjuster ensures that a width of a Y-direction (edge) of a large mesh is the same as a width of an X-direction (edge) when the red stereoscopic image generator 120 and the blurred 5 m-DEM smooth red stereoscopic image generator 250 perform plane rectangular coordinate conversion. In other words, the X direction (edge) is moved upward (+ direction) so that the Y direction (edge in the longitudinal direction) equals the width of the X direction (edge in the latitudinal direction). This is referred to as an adjustment in the X direction.

The present invention can be used to create maps (including seabed).

### Second Embodiment: (Lab Colorization)

Images become clearer when a L*a*b* colorization process is applied to images (fractal terrain stereoscopic visualization image KGi, 5 m-DEM red stereoscopic map image Ki) according to the first embodiment described above. The image subjected to L*a*b* colorization will be referred to as a L*a*b* color-imparted fractal image HKLi in the present embodiment. In addition, the computer processing system (program) will be referred to as a Lab color fractal terrain stereoscopic visualization image generation system in the present embodiment.

For example, ensure that the valleys aren't too dark, a water systems aren't hard to follow, and aren't too dark and difficult to follow, etc.

The L*a*b* colorization process described above uses the “completed 50 m-DEM thinned to 5 m-DEM smoothed and blurred red DEM” and the red stereoscopic image 5 m-DEM.

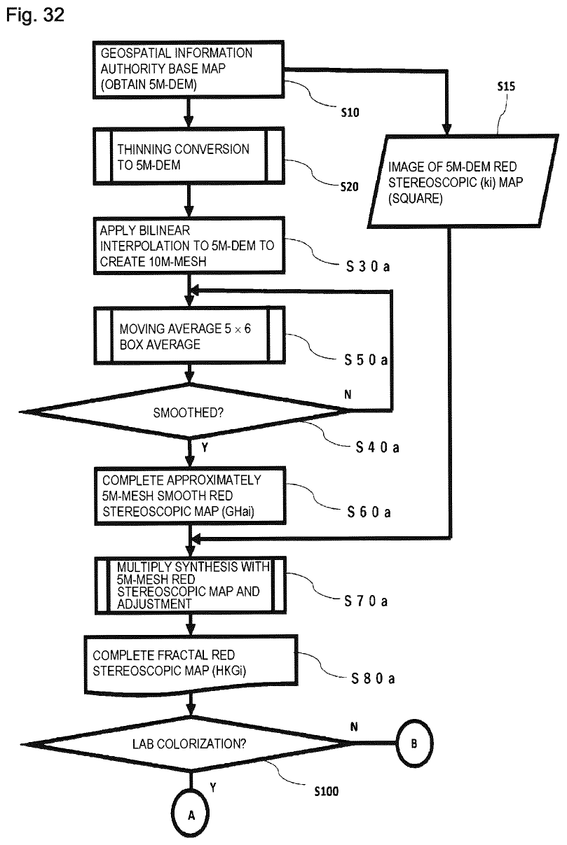

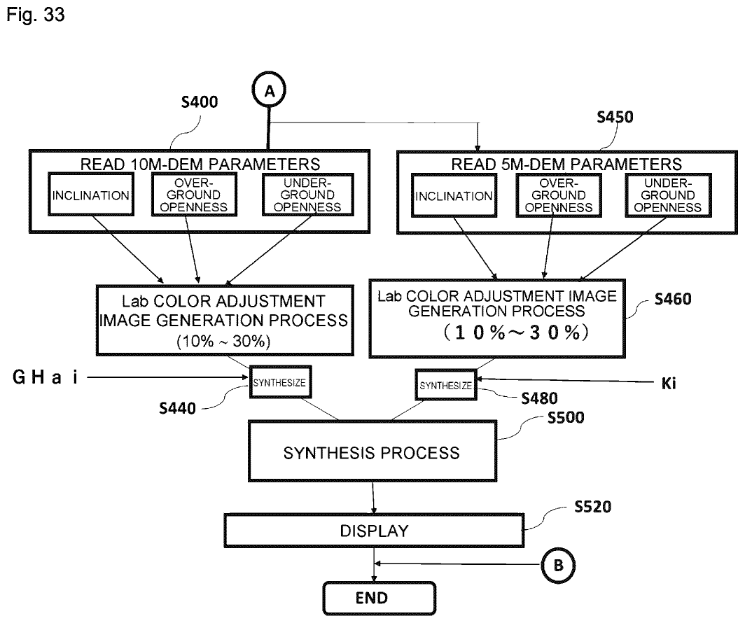

FIGS. 32 and 33 are schematic flowcharts explaining the Lab color fractal terrain stereoscopic visualization image generation system. In the present embodiment, since clusters of points of the base map (5 m-DEM) are thinned and converted into a 50 m-DEM and a 10 m-DEM obtained by further miniaturization (super-resolution) of the 50 m-DEM is used (the 10 m-DEM may be miniaturized to a 5 m-DEM), the present embodiment will be described using symbols that differ from those of the first embodiment.

As illustrated in FIG. 32, a base map (5 m-DEM (A)) defined using latitude and longitude of the Geospatial Information Authority stored in a memory is read (S10). In addition, a red stereoscopic image 5 m-DEM is generated (S15).

In other words, a 5 m-DEM red stereoscopic map image Ki is generated based on the red stereoscopic image 5 m-DEM.

In addition, clusters of points of the read 5 m-DEM (base map (5 m-DEM (A)) is thinned and converted into a 50 m-DEM (S20).

For example, a description will be given for 10 m (could be 5 m, 15 m, or 25 m) (in other words, 50 m divided by 5). By adopting 5×5 (10 m-mesh), processing speed becomes about four times faster. Then, the 50 m-DEM is subjected to 5×5 interpolation (TIN bilinear interpolation) to generate a fine fractal mesh of an approximately 10 m-mesh (also referred to as a super-resolution fractal fine 10 m-mesh) (S30a). The DEM is referred to as a “50 m-DEM thinned to 10 m-DEM”.

Next, a smoothing process is performed by applying a 5×5 moving average mesh (also referred to as a filter: 5×5 box average) to the “50 m-DEM thinned to 10 m-DEM” having been converted to super-resolution, and the smoothed image is displayed on a screen (S50a).

The image after the moving average is referred to as a “50 m-DEM thinned to 10 m-DEM smoothed and blurred image AGai (not illustrated)” (also referred to as a 10 m-DEM smoothed and blurred image). Then, an operator determines whether or not the “50 m-DEM thinned to 10 m-DEM smoothed and blurred image AGai” is smooth (S40a).

When it is determined that the image AGai is not smooth, the smoothing process of step S50a is performed once again.

When it is determined in step S40a that the image AGai is smooth, the image AGai is stored in a memory as a “completed 50 m-DEM thinned to 10 m-DEM smoothed and blurred DEM”, and using the “completed 50 m-DEM thinned to 10 m-DEM smoothed and blurred DEM”, a red image (hereinafter, referred to as a completed 10 m-mesh smooth image GHai: not illustrated) is generated in a memory (S60a). The completed 10 m-mesh smooth image GHai (also simply referred to as a 10 m “blurred” image) will be described later.

Then, the 5 m-DEM red stereoscopic map image Ki generated in step S15 and the “completed 10 m-mesh smooth image GHai” are synthesized by multiplication and color values are adjusted (S70a), and stored as a “fractal red stereoscopic completed DEM” in a memory (S80a). An image based on the “fractal red stereoscopic completed DEM” is referred to as a completed image of a fractal red relief image map (hereinafter, referred to as a completed fractal terrain stereoscopic visualization image HKGi (not illustrated)).

Then, as illustrated in FIG. 32, a determination is made as to whether or not an instruction to perform L*a*b* colorization has been issued (S100).

In step S100, when it is determined that L*a*b* colorization is to be performed, the L*a*b* color process illustrated in FIG. 33 is performed. The L*a*b* color process includes a 10 m-DEM Lab color adjustment image generation process (also referred to as a 10 m-DEM super-resolution Lab color adjustment image generation process), a 10 m-DEM super-resolution L*a*b* color synthesis process, a 5 m-DEM L*a*b* color adjustment image generation process (also referred to as a 5 m-DEM normal L*a*b* color adjustment image generation process), and a 5 m-DEM L*a*b* color synthesis process (also referred to as a normal L*a*b* color synthesis process).

As illustrated in FIG. 33, the L*a*b* color process involves the 10 m-DEM L*a*b* color adjustment image generation process (also referred to as the 10 m-DEM super-resolution L*a*b* color adjustment image generation process) reading parameters including a slope gradient (also referred to as an inclination: second slope gradient), an over-ground openness (second over-ground openness), and an under-ground openness (second under-ground openness) when obtaining the “completed 10 m-mesh smooth image GHai” (after super-resolution) obtained in step S60a (S400).

In the present embodiment, in order to distinguish an image of an over-ground openness of the 10 m super-resolution mesh from the first embodiment, an image of an over-ground openness of the 10 m super-resolution mesh is simply referred to as an over-ground openness image Dpa in the present embodiment, an image of an under-ground openness of the 10 m super-resolution mesh is simply referred to as an under-ground openness image Dqa in the present embodiment, and an image of a slope gradient (also referred to as an inclination) is simply referred to as a slope-gradient emphasis image Dra.

The 10 m-DEM Lab color adjustment image generation process (10 m-DEM super-resolution Lab color adjustment image generation process) generates a “10 m-mesh smooth Lab color image Lai (not illustrated)” by a moving average process similar to that described earlier (S420).

The 10 m-DEM Lab color adjustment image generation process (S420) involves reading image data of a super-resolution mesh (10 m) of the over-ground openness image Dpa and obtaining a* data assigned to the a* channel for each read.

In addition, image data of a super-resolution mesh (10 m) of the under-ground openness image Dqa is read and b* data assigned to the b* channel is obtained for each read.

Furthermore, image data of the slope-gradient emphasis image Dra is read and L* data assigned to the L* channel is obtained for each read.

Every time a* data, b* data, and L* data are obtained, the data is defined in a L*a*b* space to obtain the “10 m-mesh smooth Lab color image Lai (not illustrated)”.

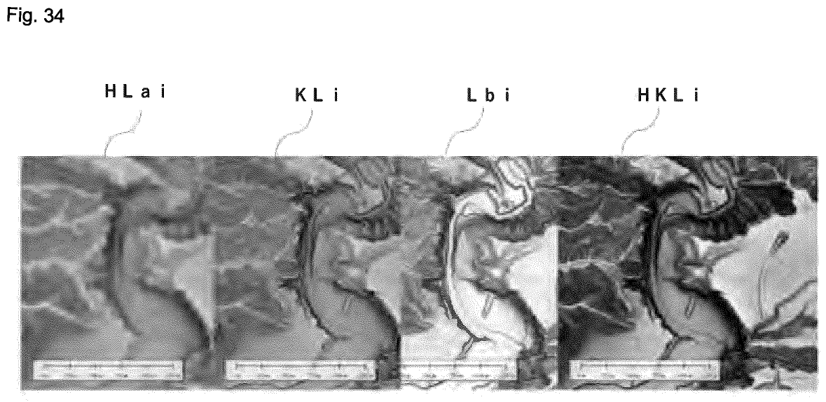

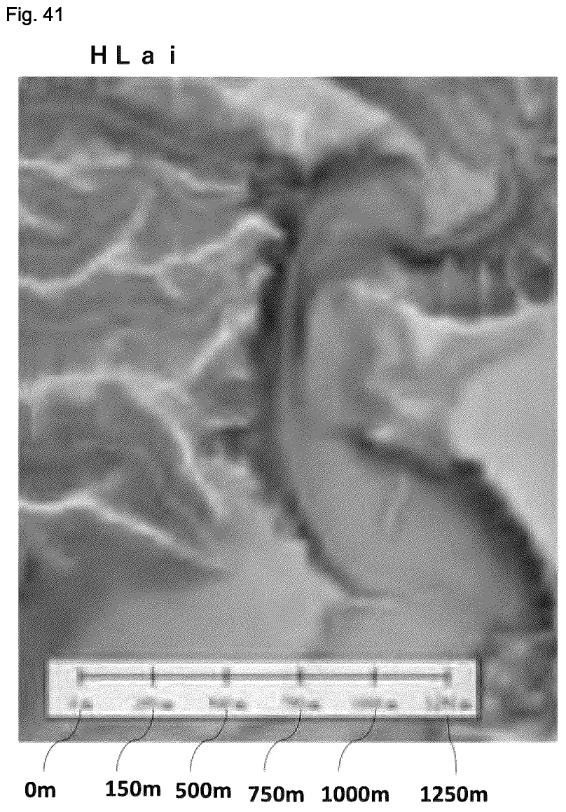

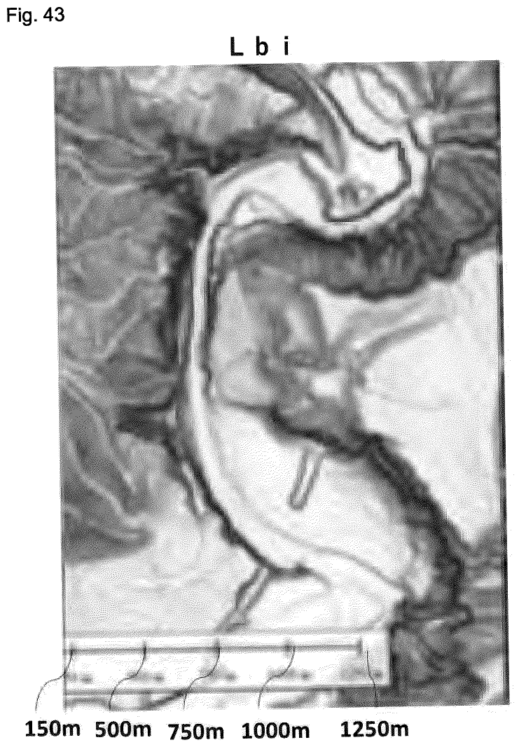

Then, the 10 m-DEM super-resolution Lab color synthesis process synthesizes (synthesizes by multiplication) the “10 m-mesh smooth Lab color image Lai (also referred to as a super-resolution smooth Lab color-imparted image)” and the “completed 10 m-mesh smooth image GHai” (after super-resolution) in step S60a to obtain the “10 m-mesh smooth L*a*b* color-imparted image HLai (also referred to as a second L*a*b* color-imparted stereoscopic visualization image)” illustrated in FIGS. 34 and 41 (S440). Since the “10 m-mesh smooth Lab color image Lai” is similar to the 5 m-DEM L*a*b* color-imparted image Lbi (also referred to as a normal Lab color-imparted image or a first L*a*b* color-imparted stereoscopic visualization image) in FIGS. 34 and 43 to be described later, the “10 m-mesh smooth Lab color image Lai” is not illustrated.

In addition, FIG. 41 illustrates an enlarged view of the “10 m-mesh smooth L*a*b* color-imparted image HLai”. Transparency of the “10 m-mesh smooth Lab color image Lai” of the “10 m-mesh smooth L*a*b* color-imparted image HLai” is set to about 10%.

On the other hand, the 5 m-DEM Lab color adjustment image generation process (5 m-DEM normal Lab color adjustment image generation process) determines an over-ground openness and an under-ground openness to determine a ridge-valley value (also referred to as an elevation-depression degree) for each 5 m-mesh in order to obtain the 5 m-DEM red stereoscopic map image Ki (not converted to super-resolution) generated in step S15. Note that a gradation color value (reddish color) indicating a color value of a combination of the ridge-valley value and the slope gradient (also referred to as inclination) is assigned to the 5 m-mesh.

In the present embodiment, an image of an over-ground openness when obtaining the 5 m-DEM red stereoscopic map image Ki is simply referred to as an over-ground openness image Dp, an image of an under-ground openness is simply referred to as an under-ground openness image Dq in the present embodiment, and an image of a slope gradient is simply referred to as a slope-gradient emphasis image Dr in a similar manner to the first embodiment.

Then, the 5 m-DEM L*a*b* color adjustment image generation process (5 m-DEM normal L*a*b* color adjustment image generation process) similarly generates a 5 m-DEM L*a*b* color-imparted image Lbi (refer to FIGS. 34 and 43) in which the over-ground openness has been converted into a* of L*a*b* color, the under-ground openness has been converted into b+, and the slope gradient (also referred to as an inclination) has been converted into L+ (S460).

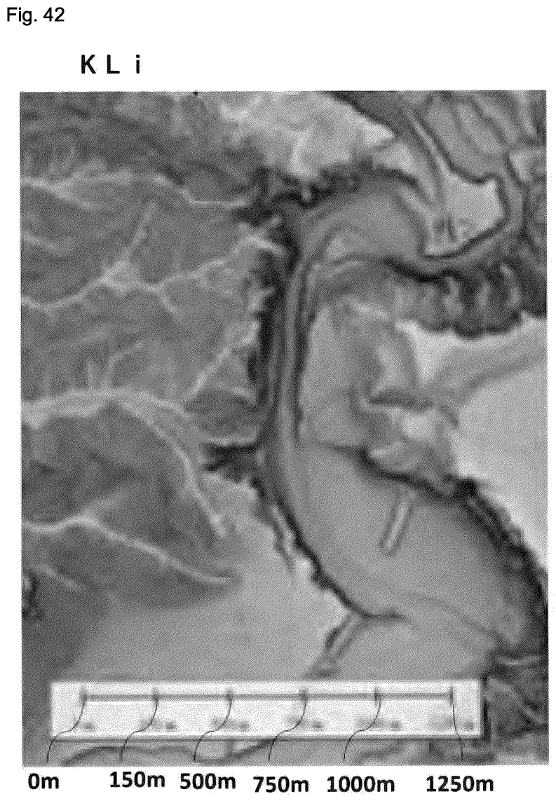

Then, the 5 m-DEM L*a*b* color synthesis process obtains a 5 m-DEM L*a*b* color image KLi created by synthesizing (synthesizing by multiplication) the 5 m-DEM red stereoscopic map image Ki (not converted to super-resolution) and the 5 m-DEM L*a*b* color-imparted image Lbi (normal Lab color-imparted image: refer to FIGS. 34 and 43) (S480: refer to FIGS. 34 and 42). The 5 m-DEM L*a*b* color-imparted image Lbi of the 5 m-DEM L*a*b* color image KLi in FIGS. 34 and 42 is an example of setting the transparency of L*a*b* to 20%.

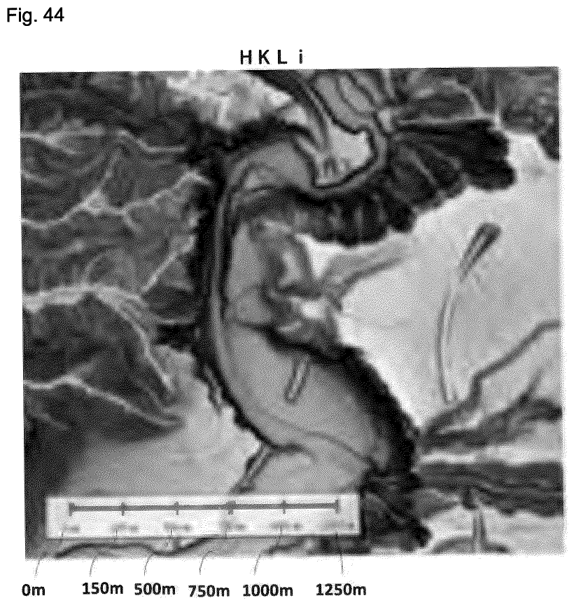

Then, the image synthesis process synthesizes (synthesizes by multiplication) the “10 m-mesh smooth L*a*b* color-imparted image HLai (super-resolution smooth Lab color-imparted image)” in step S440 and the 5 m-DEM L*a*b* color-imparted image Lbi (normal Lab color-imparted image) in step S480 to generate the L*a*b* color-imparted fractal image HKLi (refer to FIGS. 34 and 44) (S500), and displays the L*a*b* color-imparted fractal image HKLi (S520). More specifically, the synthesized image is considered a tentative L*a*b* color-imparted fractal image, and color values as viewed from a predetermined direction (the direction of the sun) are adjusted with respect to the tentative L*a*b* color-imparted fractal image to obtain the L*a*b* color-imparted fractal image HKLi.

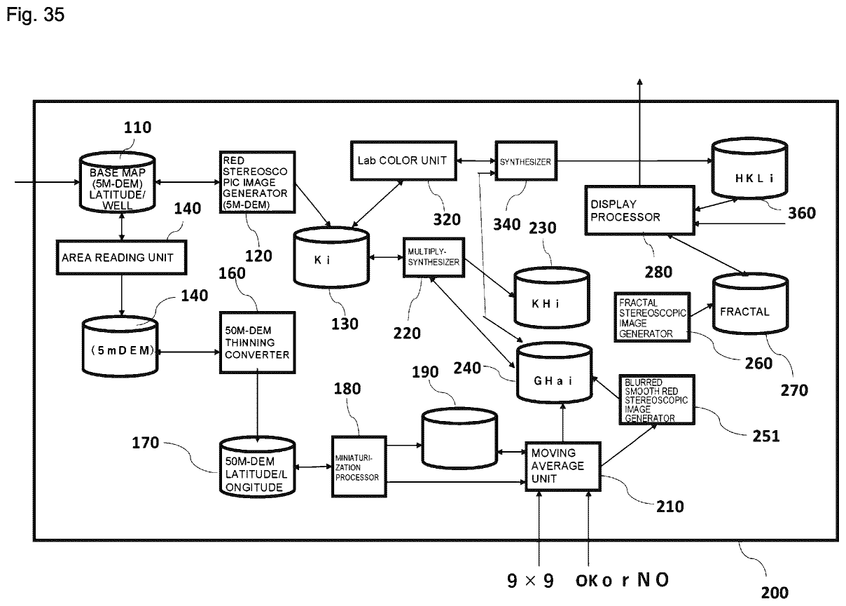

FIG. 35 is a schematic configuration diagram of the Lab color fractal terrain stereoscopic visualization image generation system. Descriptions of parts in FIG. 35 that are denoted by the same reference numerals as described above will not be repeated.

The present embodiment includes a L*a*b* color unit 320, a synthesizer 340, and the like in addition to the respective system components illustrated in FIG. 3 and described above. Note that the blurred 5 m-DEM smooth red stereoscopic image generator 250 is referred to as a blurred and smoothed red stereoscopic image generator 251 in the present embodiment. In addition, the “blurred 5 m-DEM smoothed data hgi” will be referred to as “super-resolution smoothed data hgi′”.

In addition, it is assumed that the “completed 10 m-mesh smooth image GHai (after super-resolution)” has been generated in the memory 240.

Furthermore, it is assumed that the 5 m-DEM red stereoscopic map image Ki (red stereoscopic image data Kmi) has been generated in the memory 130.

The blurred and smoothed red stereoscopic image generator 251 performs a red stereoscopic visualization process (“blurred” stereoscopic visualization process) using the “super-resolution smoothed data hgi′”. In other words, for each subject point, a ridge-valley value between the subject point and an mbi adjacent to the subject point is determined, and the “completed 10 m-mesh smooth image GHai” (after super-resolution) that is a set of data in which a gradation color value indicating a color value of a combination of the ridge-valley value and a slope gradient is assigned to the mbi of the subject point is generated in the memory 240.

The L*a*b* color unit 320 (Lab color process) includes a 10 m-DEM L*a*b* color adjustment image generation process (also referred to as a 10 m-DEM super-resolution L*a*b* color adjustment image generation process), a 10 m-DEM super-resolution L*a*b* color synthesis process, a 5 m-DEM L*a*b* color adjustment image generation process (also referred to as a 5 m-DEM normal L*a*b* color adjustment image generation process), and a 5 m-DEM L*a*b* color synthesis process (also referred to as a normal L*a*b* color synthesis process).

The 10 m-DEM L*a*b* color adjustment image generation process converts a super-resolution over-ground openness (parameter) of the over-ground openness image Dpa when obtaining the “completed 10 m-mesh smooth image GHai (after super-resolution)” into a⁺ of L*a*b* color, converts a super-resolution under-ground openness (parameter) of the under-ground openness image Dqa into b*, and converts a super-resolution slope gradient (parameter: also referred to as an inclination) of the slope-gradient emphasis image Dra into L*, and stores the converted parameters in a memory (not illustrated).

Then, by defining the data in a L*a*b* space, the “10 m-mesh smooth L*a*b* color image Lai” (refer to FIG. 43) is obtained and stored in a memory (not illustrated).

The 10 m-DEM super-resolution L*a*b* color synthesis process synthesizes (synthesizes by multiplication) the “10 m-mesh smooth L*a*b* color image Lai (super-resolution smooth L*a*b* color-imparted image)” and the “completed 10 m-mesh smooth image GHai (after super-resolution)” to obtain the “10 m-mesh smooth L*a*b* color-imparted image HLai” illustrated in FIGS. 34 and 41 (refer to FIG. 41).

On the other hand, the 5 m-DEM L*a*b* color adjustment image generation process (5 m-DEM normal L*a*b* color adjustment image generation process) generates a 5 m-DEM L*a*b* color-imparted image Lbi (refer to FIG. 43) in which the over-ground openness has been converted into a* of L*a*b* color, the under-ground openness has been converted into b*, and the slope gradient (inclination) has been converted into L*.

Then, the 5 m-DEM L*a*b* color synthesis process obtains a 5 m-DEM L*a*b* color image KLi created by synthesizing (synthesizing by multiplication) the 5 m-DEM red stereoscopic map image Ki (not converted to super-resolution) and the 5 m-DEM L*a*b* color-imparted image Lbi (normal L*a*b* color-imparted image: refer to FIGS. 34 and 43) (refer to FIGS. 34 and 42).

The synthesizer 340 (image synthesis process) synthesizes (synthesizes by multiplication) the “10 m-mesh smooth L*a*b* color-imparted image HLai (super-resolution smooth L*a*b* color-imparted image)” and the 5 m-DEM L*a*b* color-imparted image Lbi (normal L*a*b* color-imparted image) to generate a L*a*b* color-imparted fractal image HKLi (refer to FIGS. 34 and 44) in a memory 360. More specifically, the synthesized image is considered a tentative L*a*b* color-imparted fractal image, and color values as viewed from a predetermined direction (the direction of the sun) are adjusted with respect to the tentative L*a*b* color-imparted fractal image to obtain the L*a*b* color-imparted fractal image HKLi, which is then stored in the memory 360.

A display processor 200 includes a display memory (not illustrated), reads data in accordance with an entered image type into the display memory, and displays images (for example, the L*a*b* color-imparted fractal image HKLi and the “completed 10 m-mesh smooth image GHai” (after super-resolution)) of a color value assigned to the data on the screen of the display.

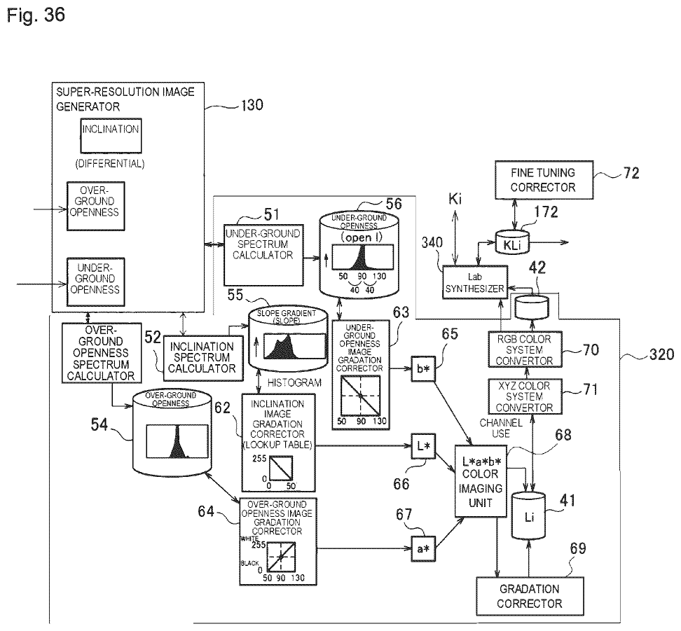

The description of the L*a*b* color unit 320 provided earlier will be supplemented using FIG. 36. FIG. 36 is a schematic configuration diagram of the L*a*b* color unit 320. However, the memory 130, the synthesizer 340, a fine tuning corrector 72, and the like are described.

As illustrated in FIG. 36, the L*a*b* color unit 320 includes an inclination image gradation corrector 62, an over-ground openness image gradation corrector 64, an under-ground openness image gradation corrector 63, an L* channelizing unit 66, a b* channelizing unit 65, an a* channelizing unit 67, an L*a*b* color imaging unit 68, a gradation corrector 69, an XYZ color system converter 71, an RGB color system converter 70, the fine tuning corrector 72, an inclination spectrum calculator 52, an under-ground openness spectrum calculator 51, an over-ground openness spectrum calculator 53, and the like and adjusts images so that valleys and depressions with a high under-ground openness become cyan while ridges and peaks with a high over-ground openness become red. Valley slopes and the like with low over-ground openness are greenish in color.

Images (“10 m-mesh smooth L*a*b* color-imparted image HLai”, L*a*b* color-imparted fractal image HKLi) are obtained which solve a problem in that valleys are dark and difficult to see by adjusting and improving the expression of valleys that are too dark to be seen to cyanish colors. A dark cyan color gives a sense of depth.

However, transparency is adjusted.

The inclination spectrum calculator 52 calculates a spectrum distribution (also referred to as a slope-gradient spectrum) of the super-resolution slope-gradient emphasis image Dra in the memory 130 and stores the calculated spectrum distribution in a memory 55.

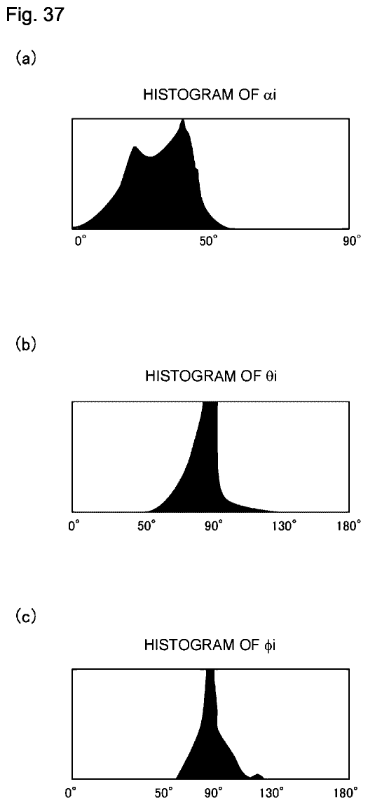

The slope-gradient spectrum of the super-resolution slope-gradient emphasis image Dr is shown in FIG. 37(a) as a histogram with the slope gradient (0 degree to 90 degrees) on an axis of abscissa and pixel frequency (n) on an axis of ordinate. As illustrated in FIG. 37(a), the slope gradient αi is essentially distributed between 0 degree and 50 degrees.

The over-ground openness spectrum calculator 53 calculates a spectrum distribution (also referred to as an over-ground openness spectrum) of the super-resolution over-ground openness emphasis image Dp in the memory 130 and stores the calculated spectrum distribution in a memory 54.

The over-ground openness spectrum is shown in FIG. 37(b) as an over-ground openness histogram with openness (0 degree to 180 degrees) on an axis of abscissa and pixel frequency (n) on an axis of ordinate. As illustrated in FIG. 37(b), the over-ground openness θi is essentially distributed between 0 degree and 90 degrees (center is 90 degrees: side of 90 degrees to 130 degrees is sharp).

The under-ground openness spectrum calculator 51 calculates a spectrum distribution (also referred to as an under-ground openness spectrum) of the super-resolution under-ground openness emphasis image Dq in the memory 130 and stores the calculated spectrum distribution in a memory 53.

The under-ground openness spectrum is shown in FIG. 37(c) as an under-ground openness histogram with under-ground openness (0 degree to 180 degrees) on an axis of abscissa and pixel frequency (n) on an axis of ordinate. As illustrated in FIG. 37(c), the under-ground openness qi is essentially distributed between 50 degrees and 130 degrees (center is 90 degrees: side of 50 degrees to 90 degrees is sharp).

### (Description of Image Gradation Unit)

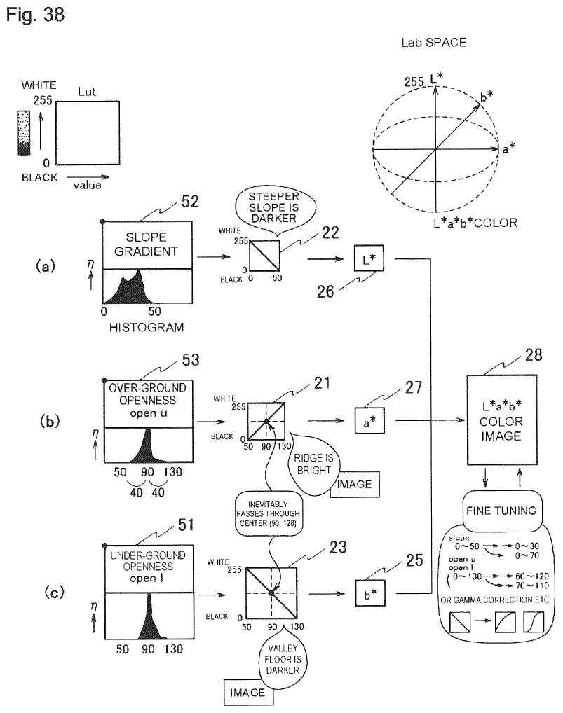

The inclination image gradation corrector 62 corrects gradation so that the steeper the slope, the darker the color. In other words, a linear conversion is performed in which an input side (axis of abscissa) is set to slope gradient 0 degree to slope gradient 50 degrees, an output side is set to 0 (black) to 255 (white), and a slope gradient αi of 50 degrees is converted to “0” while a slope gradient αi of 0 degree is converted into a maximum value of 255 (see FIG. 38(a)). Specifically, a look-up table is used.

A histogram of slope gradient obtained by the conversion described above is illustrated in FIG. 37(a).

The over-ground openness image gradation corrector 63 corrects gradation so that ridgelines are light. In other words, a linear conversion is performed in which an input side (axis of abscissa) is set to over-ground openness 50 degrees to over-ground openness 130 degrees, an output side is set to 0 (black) to 255 (white), and an over-ground openness θi of 50 degrees is converted to “0” while an over-ground openness θi of 130 degrees is converted into a maximum value of 255 (see FIG. 38(b)).

However, conversion is performed to “120 degrees” when the over-ground openness θi is 90 degrees. Specifically, a look-up table is used. In other words, as illustrated in FIG. 38(b), a center of the conversion line passes through (90 degrees, 120). An over-ground histogram obtained by the conversion described above is illustrated in FIG. 37(b).

The under-ground openness image gradation corrector 64 corrects gradation so that a line of a valley is dark. In other words, a linear conversion is performed in which an input side (axis of abscissa) is set to under-ground openness 50 degrees to under-ground openness 130 degrees, an output side is set to 0 (black) to 255 (white), and an under-ground openness φi of 50 degrees is converted to “255” while an under-ground openness φi of 130 degrees is converted into “0” (see FIG. 38(c)). However, conversion is performed to “120” to the output when the under-ground openness φi is 90 degrees. Specifically, a look-up table is used. A histogram of under-ground openness obtained by the conversion described above is illustrated in FIG. 37(c).

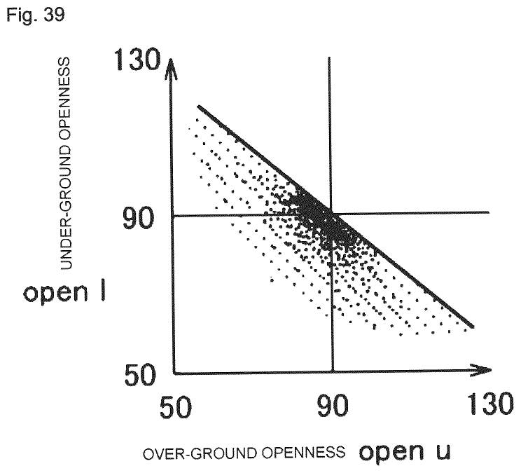

In other words, a relationship between over-ground openness and under-ground openness by the gradient conversion unit is illustrated in FIG. 39 as a scatter diagram. FIG. 39 plots the over-ground openness (50 degrees to 130 degrees) on an axis of abscissa and the under-ground openness (50 degrees to 130 degrees) on an axis of ordinate. The scatter diagram is centered on (90 degrees, 90 degrees). The scatter diagram shows that the closer to the straight line, more blue, the further away from the straight line, more yellow, and even further away, more red.

The color of the plot points indicates a color corresponding to an amount of inclination of a same subject point. FIG. 39 shows that there is an inversely proportional relationship between over-ground openness and under-ground openness. This relationship becomes stronger the shorter the distance. The over-ground openness is large and the under-ground openness is small in ridge areas while the over-ground openness is small and the under-ground openness is large in valley areas.

The color of the plot points indicate that there is a weak proportional relationship between the sum of over-ground openness and under-ground openness and inclination.

### (Channelizing Unit)

Every time the inclination image gradation corrector 62 converts a slope gradient (0 degree to 50 degrees) into a color value (255 to 0), the L* channelizing unit 66 assigns the color value to the L* channel (see FIG. 38(a)).

Every time the over-ground openness image gradation corrector 63 converts an over-ground openness θi (50 degrees to 130 degrees) into a color value (0 to 255), the a* channelizing unit 67 assigns the color value to the a* channel.

Every time an under-ground openness φi (50 degrees to 130 degrees) is converted into a color value (255 to 0), the b* channelizing unit 65 assigns the color value to the b* channel.

The L*a*b* color imaging unit 68 defines L* data of the L* channelizing unit 66, a* data of the a* channelizing unit 67, and b* data of the b* channelizing unit 65 in the L*a*b* space and obtains a super-resolution Lab color image Li (Lai, Lbi) in a memory 41 (see FIG. 43).

### Other

While the corrector 69 may define L*a*b* color images Li (Lai, Lbi) in the RGB space to be synthesized with the 5 m-DEM red stereoscopic map image Ki and the completed 10 m-mesh smooth image GHai, since the L*a*b* color images Li have a wider color space than the RGB space, the corrector 69 uses a toe curve to perform fine adjustment after approximate color adjustment is performed by level correction.

For example, a slope gradient of 0 degrees to 50 degrees is changed to 0 degree to 30 degrees or 0 degree to 70 degrees to be reassigned a color value. In addition, an over-ground openness (50 degrees to 130 degrees) or an under-ground openness (50 degrees to 130 degrees) is changed to 60 degrees to 120 degrees or 70 degrees to 110 degrees to be reassigned a color value.

The XYZ color system converter 71 converts a Lab adjusted image into the XYZ color system (defines in a color space memory of the XYZ color system) (Lab image of XYZ color system).

The RGB color system converter 70 converts a Lab image in the XYZ color system into the RGB color system (defines in a RGB space memory) (Lab image of RGB layer). The Lab image of the RGB layer is stored in a memory 42.

The synthesizer 340 (image synthesis process) superimposes the “10 m-mesh smooth L*a*b* color-imparted image HLai (super-resolution smooth L*a*b* color-imparted image)”, the 5 m-DEM L*a*b* color-imparted image Lbi (normal L*a*b* color-imparted image), and the Lab image of the RGB layer on the red stereoscopic visualization image (5 m-DEM red stereoscopic map image Ki, fractal terrain stereoscopic visualization image KGi) stored in a file 40. The image is referred to as a L*a*b* fractal stereoscopic image HLai and is stored in the memory 360. However, color values as viewed from a predetermined direction (the direction of the sun) are adjusted with respect to the tentative L*a*b* color-imparted fractal image to obtain the L*a*b* color-imparted fractal image HKLi.

The fine tuning corrector 72 adjusts a contrast (transparency) or the like of the L*a*b* color (by operator input).

In other words, by overlapping and synthesizing these images, the expression of valleys that have become too dark is adjusted and improved to cyanish colors. Therefore, the valley is neither dark nor difficult to see.

### Third Embodiment

The third embodiment represents a method of emphasizing water systems.

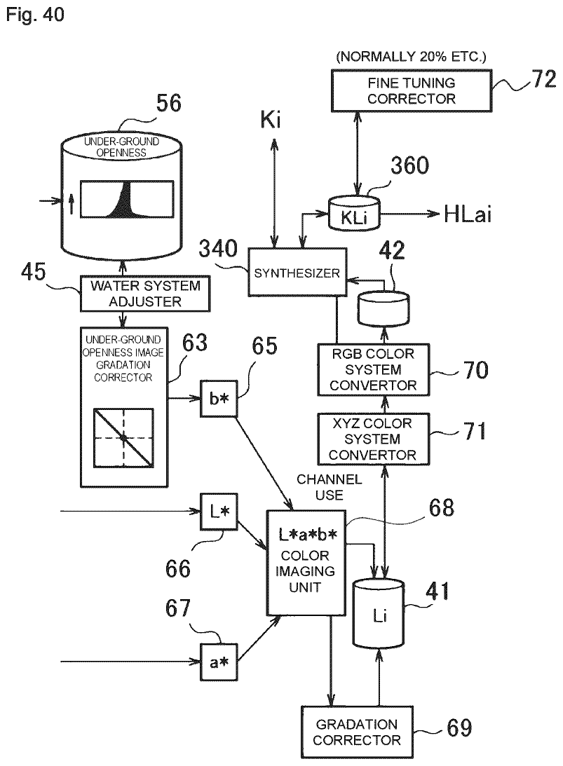

FIG. 40 is a schematic configuration diagram of the third embodiment. Duplicate explanations are omitted for parts denoted by the same reference numerals as described above. As illustrated in FIG. 40, a water system adjuster 45 is provided. The water system adjuster 45 skips the bright side of a histogram of under-ground openness and adjusts an image to be only on the dark side. Accordingly, a portion where under-ground openness is high (portion relatively lower than valley portions or periphery) is extracted.

Then, in a similar manner to the second embodiment, the L*a*b* color image Li and the red stereoscopic image are superimposed.

Note that unlike contour maps and the like, a red relief image map has no concept of height and only expresses unevenness. Therefore, when there is a large difference in elevation within a target area, an overall undulations sensation may not be sufficient. When a large terrain is represented on a red relief image map, this can be achieved by increasing the range of consideration of the degree of openness according to the scale of the represented terrain (in other words, when desiring to see terrain undulations in an area of about 1 km, a range of the degree of openness is set to 1000 m).

However, in practice, the calculation of the degree of openness is regulated by microtopography that exists around a location of interest and the degree of openness of 1 km ahead is seldom calculated.

For example, if a range of the degree of openness such as 1 km is set with respect to 1 m-DEM, the value of the degree of openness will be saturated in valley and ridge portions, causing the valleys to become too dark and the ridges to become too light.

This problem is solved by reducing the resolution of the DEM to be calculated (reducing the resolution of the terrain) and then performing a calculation.

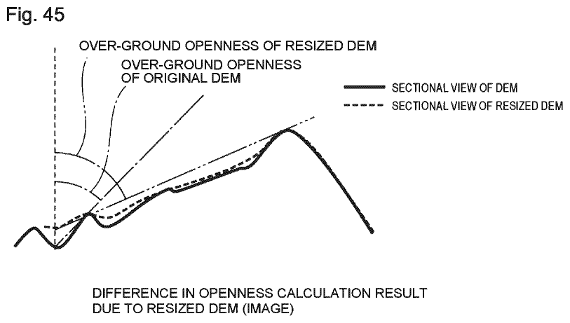

This allows for calculations that take the earth system into account (see FIG. 45).

Between 1 m-DEM and 4 m-DEM, 4 m-DEM provides a stronger sense of undulation as a whole.

In addition, the methods according to the embodiments described above can be applied to the topography of Venus and Mars. Furthermore, it can also be applied to the visualization of unevenness measured with an electron microscope. When applied to gaming devices, it provides a stereoscopic effect without the need for glasses.

While a super-resolution image is generated using an elevation-depression degree (ridge-valley value) obtained from over-ground openness and under-ground openness in the embodiments described above, the super-resolution image may be superimposed and displayed on an image obtained by sky coverage, a topographic protection factor, a plane curvature, a high-pass filter, or a Mexican hat function.

Alternatively, an image can be created by inverting the sky coverage, the topographic protection factor, the plane curvature, the high-pass filter, the Mexican hat function, or the like and the image can be adopted as an under-ground openness image.

Note that the DEM of a base map may be ALB (Airborne lidar Bathymetry) (point cloud density: 1 point/m2).

### REFERENCE SIGNS LIST

110 ground map memory
120 red stereoscopic image generator
140 area reading unit
160 thinning 50 m-DEM converter
180 miniaturization processor
210 moving average unit
220 multiply synthesizer
250 blurred 5 m-DEM smooth red stereoscopic image generator
260 fractal stereoscopic image generator
280 display processor

1. A fractal terrain stereoscopic visualization image generation system, comprising:
a storage that stores a DEM of terrain defined by a mesh of a certain size as a digital elevation model;
(A). means of obtaining a first elevation-depression degree using a first over-ground openness and a first under-ground openness based on a DEM of terrain of a predetermined area of the digital elevation model and a DEM of terrain within a consideration distance, further obtaining a first slope gradient, and generating a stereoscopic visualization image in a first gradation color of a combination of the first elevation-depression degree and the first slope gradient;
(B). means of generating a large mesh several times larger than a mesh of the DEM of terrain of the predetermined area, and reading a certain number of clusters of points of the DEM of terrain in a thinned manner into the large mesh to generate a low-density large mesh DEM;
(C). means of applying an interpolation process to the low-density large mesh to generate miniaturized low-density fine meshes, and assigning an interpolated elevation value to each low-density fine mesh;
(D). means of sequentially performing a moving average process for each low-density fine mesh to determine a moving average of the interpolated elevation values;
(E). means of designating each low-density fine mesh as a subject point after the moving average process is performed by the means (D), obtaining a second elevation-depression degree using a second over-ground openness and a second under-ground openness based on a moving-averaged elevation value of the low-density fine mesh at the subject point and a moving-averaged elevation value of the low-density fine mesh within the consideration distance, further obtaining a second slope gradient, and generating an image of a combination of the second elevation-depression degree and the second slope gradient to which a second gradation color is assigned as a “blurred” stereoscopic visualization image; and
(F). means of synthesizing the stereoscopic visualization image and the “blurred” stereoscopic visualization image by multiplication and outputting the synthesized image as a fractal terrain stereoscopic visualization image.

2. The fractal terrain stereoscopic visualization image generation system according to claim 1, wherein
the means of (F)
causes the fractal terrain stereoscopic visualization image to apply a color-adjusted color value when viewed from a predetermined direction to the low-density fine mesh.

3. The fractal terrain stereoscopic visualization image generation system according to claim 1, comprising:
in a case of the large mesh that is tens of times larger than the mesh of the DEM of terrain,
(G). means of causing the means of (B) to repeat thinning of a certain number of clusters of points of the DEM of terrain a predetermined number of times.

4. The fractal terrain stereoscopic visualization image generation system according to claim 1, wherein
the means of (C)
equally divides an edge in a latitudinal direction and an edge in a longitudinal direction of the low-density large mesh into ten parts and performs the interpolation process, and
the means of (D) determines a moving average by applying a 9×9 moving average filter to the low-density large mesh after the interpolation.

5. The fractal terrain stereoscopic visualization image generation system according to claim 1, wherein
the means of (C) further
reads an elevation value of the low-density fine mesh after the moving average process to a display memory and displays as a smooth image on a screen, and performs the moving average process once again with an input of an instruction to determine a moving average.

6. The fractal terrain stereoscopic visualization image generation system according to claim 1, wherein the color tone of the first slope gradient and the second slope gradient is displayed in a reddish color.

7. The fractal terrain stereoscopic visualization image generation system according to claim 1, wherein the DEM of the digital elevation model is a 50 cm-DEM, a 1 m-DEM, a 5 m-DEM, or a 10 m-DEM.

8. The fractal terrain stereoscopic visualization image generation system according to claim 1, comprising:
(H). means of defining the first over-ground openness, the first under-ground openness, and the first slope gradient in an L*a*b* space to generate a L*a*b* color image;
(I). means of generating a first L*a*b* color-imparted stereoscopic visualization image by synthesizing the L*a*b* color image with the stereoscopic visualization image;
(J). means of defining the second over-ground openness, the second under-ground openness, and the second slope gradient in an L*a*b* space to generate a second L*a*b* color-imparted stereoscopic visualization image; and
(K). means of generating and outputting a L*a*b* color-imparted fractal terrain stereoscopic visualization image by synthesizing the first L*a*b* color-imparted stereoscopic visualization image and the second L*a*b* color-imparted stereoscopic visualization image with the “blurred” stereoscopic visualization image and displaying the L*a*b* color-imparted fractal terrain stereoscopic visualization image.

9. A fractal terrain stereoscopic visualization image generation program, causing a computer to execute functions as:
means of causing a storage to store a DEM of terrain defined by a mesh of a certain size as a digital elevation model;
(A). means of obtaining a first elevation-depression degree using a first over-ground openness and a first under-ground openness based on a DEM of terrain of a predetermined area of the digital elevation model and a DEM of terrain within a consideration distance, further obtaining a first slope gradient, and generating a stereoscopic visualization image in a first gradation color of a combination of the first elevation-depression degree and the first slope gradient;
(B). means of generating a large mesh several times larger than a mesh of the DEM of terrain of the predetermined area, and reading a certain number of clusters of points of the DEM of terrain in a thinned manner into the large mesh to generate a low-density large mesh DEM;
(C). means of applying an interpolation process to the low-density large mesh to generate miniaturized low-density fine meshes, and assigning an interpolated elevation value to each low-density fine mesh;
(D). means of sequentially performing a moving average process for each low-density fine mesh to determine a moving average of the interpolated elevation values;
(E). means of designating each low-density fine mesh as a subject point after the moving average process is performed by the means (D), obtaining a second elevation-depression degree using a second over-ground openness and a second under-ground openness based on a moving-averaged elevation value of the low-density fine mesh at the subject point and a moving-averaged elevation value of the low-density fine mesh within the consideration distance, further obtaining a second slope gradient, and generating an image of a combination of the second elevation-depression degree and the second slope gradient to which a second gradation color is assigned as a “blurred” stereoscopic visualization image; and
(F). means of synthesizing the stereoscopic visualization image and the “blurred” stereoscopic visualization image by multiplication and outputting the synthesized image as a fractal terrain stereoscopic visualization image.

10. The fractal terrain stereoscopic visualization image generation program according to claim 9, wherein
the means of (F)
causes the fractal terrain stereoscopic visualization image to apply a color-adjusted color value when viewed from a predetermined direction to the low-density fine mesh.

11. The fractal terrain stereoscopic visualization image generation program according to claim 9, causing a computer to execute functions as:
in a case of the large mesh that is tens of times larger than the mesh of the DEM of terrain,
(G). means of causing the means of (B) to repeat thinning of a certain number of clusters of points of the DEM of terrain a predetermined number of times.

12. The fractal terrain stereoscopic visualization image generation program according to claim 9, causing a computer to execute:
the means of (C) which
equally divides an edge in a latitudinal direction and an edge in a longitudinal direction of the low-density large mesh into ten parts and performs the interpolation process, and
the means of (D) which determines a moving average by applying a 9×9 moving average filter to the low-density large mesh after the interpolation.

13. The fractal terrain stereoscopic visualization image generation program according to claim 9, causing a computer to execute:
the means of (C) which further
reads an elevation value of the low-density fine mesh after the moving average process to a display memory and displays as a smooth image on a screen, and performs the moving average process once again with an input of an instruction to determine a moving average.

14. The fractal terrain stereoscopic visualization image generation program according to claim 9, causing a computer to:
display the color tone of the first slope gradient and the second slope gradient in a reddish color.

15. The fractal terrain stereoscopic visualization image generation program according to claim 9, causing a computer to:
store a 50 cm-DEM, a 1 m-DEM, a 5 m-DEM, or a 10 m-DEM as a DEM of the digital model in a storage.

16. The fractal terrain stereoscopic visualization image generation program according to claim 9, causing a computer to function as:
(H). means of defining the first over-ground openness, the first under-ground openness, and the first slope gradient in an L*a*b* space to generate a L*a*b* color image;
(I). means of generating a first L*a*b* color-imparted stereoscopic visualization image by synthesizing the L*a*b* color image with the stereoscopic visualization image;
(J). means of defining the second over-ground openness, the second under-ground openness, and the second slope gradient in an L*a*b* space to generate a second L*a*b* color-imparted stereoscopic visualization image; and
(K). means of generating and outputting a L*a*b* color-imparted fractal terrain stereoscopic visualization image by synthesizing the first L*a*b* color-imparted stereoscopic visualization image and the second L*a*b* color-imparted stereoscopic visualization image with the “blurred” stereoscopic visualization image and displaying the L*a*b* color-imparted fractal terrain stereoscopic visualization image.
